(19) United States
(12) Patent Application Publication
(10) Pub. No.: US 2026/0213349 A1
(43) Pub. Date: Jul. 23, 2026

(54) ALL-SOLID STATE BATTERY

(71) Applicant: TDK CORPORATION, Tokyo (JP)

(72) Inventors: Hiroshi SATO, Tokyo (JP); Shota SUZUKI, Tokyo (JP); Ayaka NAGATOMI, Tokyo (JP)

(73) Assignee: TDK CORPORATION, Tokyo (JP)

(21) Appl. No.: 19/140,933

(22) PCT Filed: Nov. 29, 2023
(86) PCT No.: PCT/JP2023/042732

§ 371 Date: Jun. 18, 2025

(30) Foreign Application Priority Data
Dec. 20, 2022 (JP) 2022-203082

(51) Int. Cl. H01M 50/477; H01M 4/02; H01M 10/0525; H01M 10/0585; H01M 50/474; H01M 50/548

(52) U.S. Cl. CPC H01M 50/477; H01M 10/0525; H01M 10/0585; H01M 50/474; H01M 50/548; H01M 2004/021

(57) ABSTRACT

An all-solid state battery includes a positive electrode; a negative electrode; a solid electrolyte layer between the positive electrode and the negative electrode; and a first columnar body located at a position in the same layer as that of the positive electrode or the negative electrode in a manner spaced apart from the positive electrode or the negative electrode with a void being sandwiched between the first columnar body and the positive electrode or the negative electrode.

### TECHNICAL FIELD

The present invention relates to an all-solid state battery. Priority is claimed on Japanese Patent Application No. 2022-203082, filed Dec. 20, 2022, the content of which is incorporated herein by reference.

### BACKGROUND ART

In recent years, the development of electronic technology has been remarkable. Portable electronic apparatuses are becoming smaller, lighter, thinner, and more multifunctional. In association with this, there is also a strong demand for a battery, which serves as a power source for an electronic apparatus, such that it is smaller, lighter, thinner, and more reliable, and an all-solid state battery, which uses a solid electrolyte as an electrolyte, has attracted attention.

The all-solid state battery is charged and discharged by the movement of lithium ions between the positive electrode and the negative electrode through a solid electrolyte. For example, Patent Document 1 discloses an all-solid state battery using a sintered solid electrolyte.

### CITATION LIST

### Patent Document

[Patent Document 1] PCT International Publication No. WO2008/099508

### SUMMARY OF INVENTION

### Technical Problem

A sintered all-solid state battery may undergo cracking in the inside thereof due to stress concentration occurring at the interface of each layer, which is accompanied by a sintering mismatch during sintering, volume expansion during charging and discharging, and the like. Internal cracking causes a decrease in the cycle characteristics of an all-solid state battery.

The present disclosure has been made in consideration of the above problems and aims to provide an all-solid state battery in which internal cracking is less likely to occur.

### Solution to Problem

In order to solve the above problems, the following means are provided.
(1) An all-solid state battery according to a first aspect includes a positive electrode, a negative electrode, a solid electrolyte layer, and a first columnar body. The solid electrolyte layer is present between the positive electrode and the negative electrode. The first columnar body is located at a position in the same layer as that of the positive electrode or the negative electrode in a manner spaced apart from the positive electrode or the negative electrode with a void being sandwiched between the first columnar body and the positive electrode or the negative electrode.
(2) In the all-solid state battery according to the above aspect, the first columnar body may be spaced apart from the positive electrode in the same layer as that of the positive electrode with the void being sandwiched between the first columnar body and the positive electrode.
(3) The all-solid state battery according to the above aspect may further include a second columnar body. The second columnar body is spaced apart from the negative electrode in the same layer as that of the negative electrode, with a void being sandwiched between the second columnar body and the negative electrode.
(4) The all-solid state battery according to the above aspect may further include a positive electrode terminal and a negative electrode terminal. The positive electrode terminal is connected to the positive electrode on a first surface of a laminated body including the positive electrode, the negative electrode, and the solid electrolyte layer. The negative electrode terminal is connected to the negative electrode on a second surface of the laminated body different from the first surface. The first columnar body is present between the positive electrode terminal and the negative electrode, or between the negative electrode terminal and the positive electrode.
(5) In the all-solid state battery according to the above aspect, the positive electrode terminal may be in contact with the first surface and a surface adjacent to the first surface, and the positive electrode terminal may not be in contact with the negative electrode.
(6) In the all-solid state battery according to the above aspect, the negative electrode terminal may be in contact with the second surface of the laminated body and a surface adjacent to the second surface, and the negative electrode terminal may not be in contact with the positive electrode.
(7) In the all-solid state battery according to the above aspect, the first columnar body may have the same layer configuration as the positive electrode or the negative electrode.
(8) In the all-solid state battery according to the above aspect, a thickness of the positive electrode may be 2.5 times or more with respect to a thickness of the solid electrolyte layer.
(9) In the all-solid state battery according to the above aspect, a thickness of the negative electrode may be 2.5 times or more with respect to a thickness of the solid electrolyte layer.
(10) In the all-solid state battery according to the above aspect, the positive electrode may have a thickness of 10 μm or more.
(11) In the all-solid state battery according to the above aspect, the negative electrode may have a thickness of 10 μm or more.
(12) In the all-solid state battery according to the above aspect, the positive electrode may be at least one layer, the negative electrode may be at least one layer, and
a total number of the positive electrodes and the negative electrodes may be 3 or more.
(13) In the all-solid state battery according to the above aspect, a laminated body including the positive electrode, the negative electrode, and the solid electrolyte layer may have a first positive electrode and a second positive electrode, which are adjacent to each other in a lamination direction. A first void present between the first positive electrode and the columnar body in the same layer as that of the first positive electrode and a second void present between the second positive electrode and the columnar body in the same layer as that of the second positive electrode at least partially overlap in a case of being viewed from the lamination direction of the laminated body.
(14) In the all-solid state battery according to the above aspect, 80% or more of the first void may be overlapped with the second void in a case of being viewed from the lamination direction of the laminated body.
(15) In the all-solid state battery according to the above aspect, a laminated body including the positive electrode, the negative electrode, and the solid electrolyte layer may have a first negative electrode and a second negative electrode, which are adjacent to each other in a lamination direction. A third void present between the first negative electrode and the columnar body in the same layer as that of the first negative electrode and a fourth void present between the second negative electrode and the columnar body in the same layer as that of the second negative electrode are at least partially overlapped in a case of being viewed from the lamination direction of the laminated body.
(16) In the all-solid state battery according to the above aspect, 80% or more of the third void may be overlapped with the fourth void in a case of being viewed from the lamination direction of the laminated body.
(17) The all-solid state battery according to the above aspect may further include a first region containing a solid electrolyte constituting the solid electrolyte layer between the positive electrode or the negative electrode and the first columnar body, in the same layer as that of the positive electrode or the negative electrode.
(18) The all-solid state battery according to the above aspect may further include a third columnar body between the positive electrode or the negative electrode and the first columnar body in the same layer as that of the positive electrode or the negative electrode.
(19) The all-solid state battery according to the above aspect may have a part of the first columnar body or a fourth columnar body at a position in the second direction of the positive electrode or the negative electrode. Here, a direction from the first columnar body toward the positive electrode or the negative electrode in the same layer as that of the positive electrode or the negative electrode is defined as a first direction, where the void is sandwiched between the first columnar body and the positive electrode or the negative electrode, and a direction intersecting the first direction is defined as a second direction.
(20) In the all-solid state battery according to the above aspect, a width of the void in the first direction may be 0.07 times or more or 15.0 times or less with respect to a width of the first columnar body in the first direction. Here, a direction from the first columnar body toward the positive electrode or the negative electrode in the same layer as that of the positive electrode or the negative electrode is defined as a first direction, where the void is sandwiched between the first columnar body and the positive electrode or the negative electrode.

### Advantageous Effects of Invention

Internal cracking is less likely to occur in the all-solid state battery according to the above aspect.

### BRIEF DESCRIPTION OF DRAWINGS

FIG. 1 is a cross-sectional view of an all-solid state battery according to a first embodiment.

FIG. 2 is a cross-sectional view that is obtained by cutting the all-solid state battery according to the first embodiment along the positive electrode.

FIG. 3 is a cross-sectional view that is obtained by cutting the all-solid state battery according to the first embodiment along the negative electrode.

FIG. 4 is a cross-sectional view of a characteristic portion of the all-solid state battery according to the first embodiment.

FIG. 5 is a cross-sectional view of a characteristic portion of an all-solid state battery according to a first modified example.

FIG. 6 is a cross-sectional view of a characteristic portion of an all-solid state battery according to a second modified example.

FIG. 7 is a cross-sectional view of a characteristic portion of an all-solid state battery according to a third modified example.

FIG. 8 is a cross-sectional view of a characteristic portion of an all-solid state battery according to a fourth modified example.

FIG. 9 is a cross-sectional view of a characteristic portion of an all-solid state battery according to a fifth modified example.

FIG. 10 is a cross-sectional view that is obtained by cutting an all-solid state battery according to a sixth modified example along the positive electrode.

FIG. 11 is a cross-sectional view that is obtained by cutting an all-solid state battery according to a sixth modified example along the negative electrode.

FIG. 12 is a cross-sectional view of a characteristic portion of the all-solid state battery according to the sixth modified example.

FIG. 13 is a cross-sectional view of a characteristic portion of the all-solid state battery according to the sixth modified example.

### DESCRIPTION OF EMBODIMENTS

Hereinafter, the present embodiments will be described in detail with reference to the drawings as appropriate. The drawings that are used in the following description may show characteristic portions in an enlarged scale for convenience in order to facilitate the understanding of the characteristics of the present invention, and thus the dimensional ratios or the like of the respective constitutional elements may differ from the actual ones. The materials, dimensions, and the like, which are exemplified in the following description, are merely examples, and the present invention is not limited thereto. Therefore, an appropriate modification can be made within the scope that does not deviate from the gist of the present invention.

Directions will be defined. A lamination direction of a laminated body 10 is denoted as the z direction, one direction in a plane orthogonal to the z direction is denoted as the x direction, and a direction orthogonal to the x direction and the z direction is denoted as the y direction. The x direction is, for example, a direction from a positive electrode terminal 80 toward a negative electrode terminal 90. For example, a direction from a columnar body 4 to a positive electrode 1 in the same layer as positive electrode 1 and a direction from columnar body 6 to a negative electrode 2 in the same layer as negative electrode 2 are both examples of the x direction. The x direction is an example of a first direction. In addition, the y direction is an example of a second direction. Hereinafter, one direction in the z direction may be expressed as “up” and a direction opposite to this direction may be expressed as “down”. Up and down do not necessarily correspond to the direction of gravity.

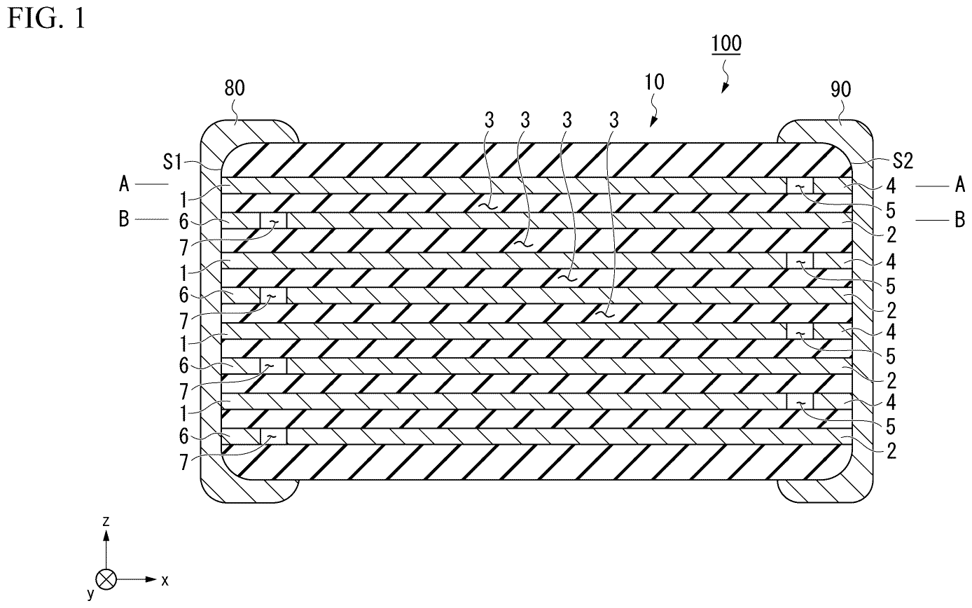

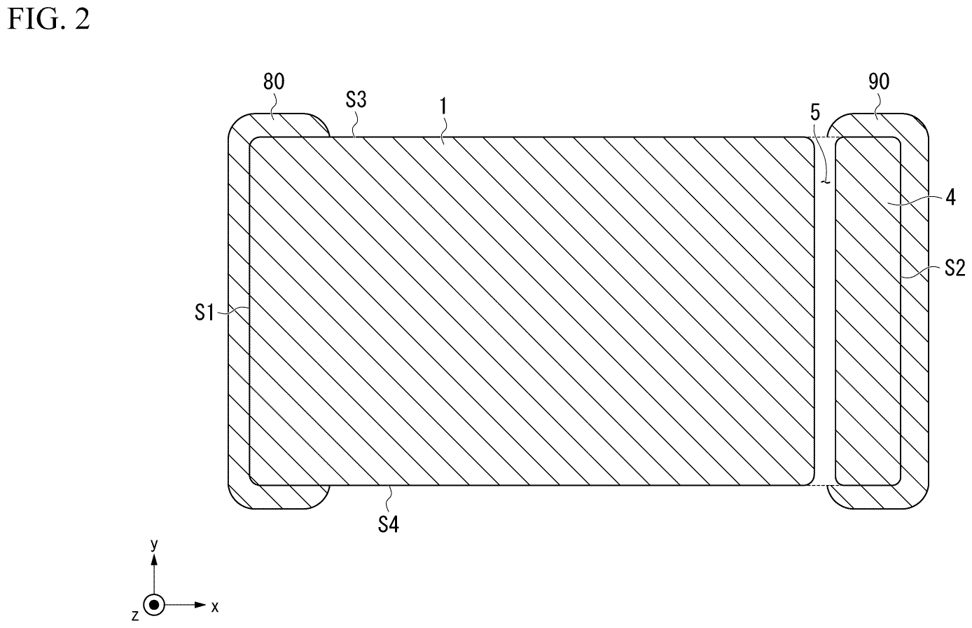

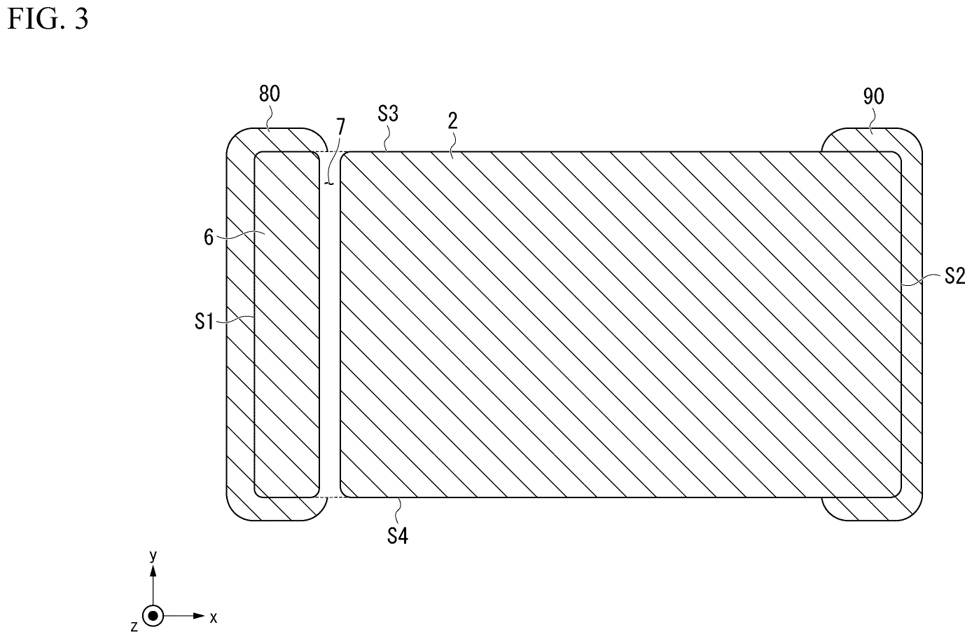

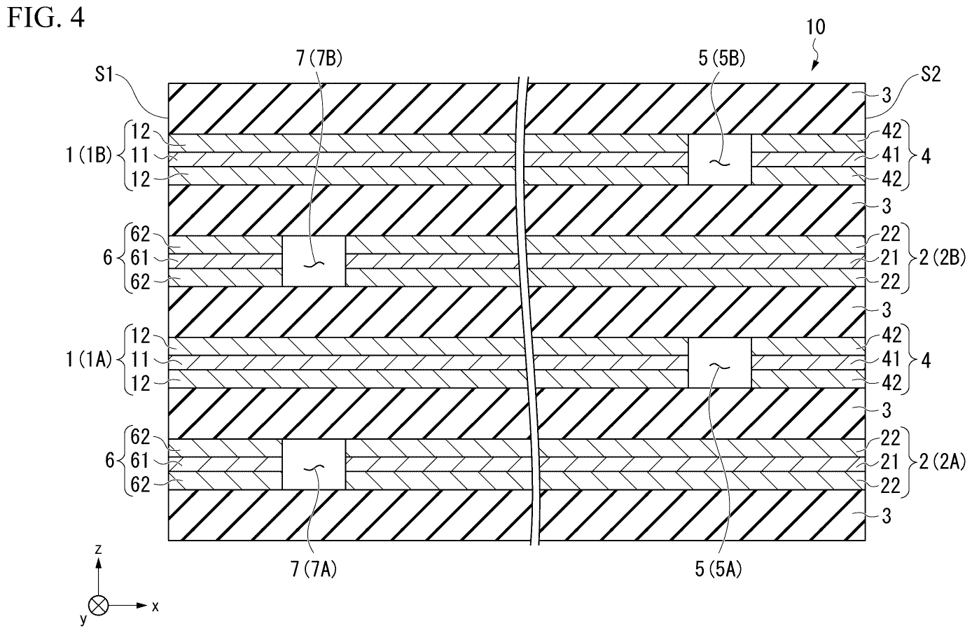

FIG. 1 is a cross-sectional view of an all-solid state battery 100 according to a first embodiment. FIG. 2 is a cross-sectional view that is obtained by cutting the all-solid state battery 100 according to the first embodiment along the positive electrode 1. FIG. 3 is a cross-sectional view that is obtained by cutting the all-solid state battery 100 according to the first embodiment along the negative electrode 2. FIG. 4 is a cross-sectional view of a characteristic portion of the laminated body 10 of the all-solid state battery 100 according to the first embodiment.

The all-solid state battery 100 has, for example, the laminated body 10, the positive electrode terminal 80, and the negative electrode terminal 90. The all-solid state battery 100 is, for example, a laminate battery, a square type battery, a cylinder type battery, a coin type battery, and a button type battery. The all-solid state battery 100 may be of a liquid injection type which is obtained by dissolving or dispersing a solid electrolyte layer 3 in a solvent.

### <Laminated Body>

The laminated body 10 has the positive electrode 1, the negative electrode 2, the solid electrolyte layer 3, the columnar body 4, and the columnar body 6. The columnar body 4 is present in the same layer as that of the positive electrode 1. A void 5 is present between the positive electrode 1 and the columnar body 4. The columnar body 6 is present in the same layer as that of the negative electrode 2. A void 7 is present between the negative electrode 2 and the columnar body 6. The columnar body 4 is an example of a first columnar body. The columnar body 6 is an example of a second columnar body.

The laminated body 10 is charged or discharged by the exchange of ions between the positive electrode 1 and the negative electrode 2 through the solid electrolyte layer 3. The laminated body 10 is, for example, a laminated body in which the positive electrode 1, the negative electrode 2, and the solid electrolyte layer 3 are laminated. The laminated body 10 may be, for example, a wound body obtained by winding a laminated body in which the positive electrode 1, the negative electrode 2, and the solid electrolyte layer 3 are laminated.

### “Positive Electrode”

The number of layers of the positive electrode 1 in the laminated body 10 does not matter. The positive electrode 1 may be singular or plural. Each positive electrode 1 extends in the xy plane. A first end of each positive electrode 1 is connected to the positive electrode terminal 80 on a first surface S1 of the laminated body 10. The second end of each positive electrode 1 is exposed to the void 5. The second end of each positive electrode 1 faces the columnar body 4 with the void 5 being sandwiched between the second end and the void 5.

The thickness of the positive electrode 1 is, for example, 2.5 times or more with respect to the thickness of the solid electrolyte layer 3. The thickness of the positive electrode 1 is, for example, 10 μm or more.

As shown in FIG. 4, the positive electrode 1 has, for example, a positive electrode current collector layer 11 and a positive electrode active material layer 12.

The positive electrode current collector layer 11 contains, for example, a highly conductive material. The positive electrode current collector layer 11 is, for example, a metal or an alloy, which contains at least one metal element selected from the group consisting of silver (Ag), palladium (Pd), gold (Au), platinum (Pt), aluminum (Al), copper (Cu), and nickel (Ni). In addition, the positive electrode current collector layer 11 may be made of a non-metal such as carbon (C) as long as it is conductive. The positive electrode current collector layer 11 is made of, for example, Ag or an AgPd alloy.

The positive electrode active material layer 12 is formed on one surface or both surfaces of the positive electrode current collector layer 11. The positive electrode active material layer 12 contains a positive electrode active material. The positive electrode active material layer 12 may contain a conductive auxiliary agent, a binding material, and a solid electrolyte described below.

The positive electrode active material is, for example, a transition metal oxide or a transition metal composite oxide. Specific examples of the positive electrode active material include lithium manganese composite oxide Li₂MnₐMa₁₋ₐO₃ (0.8≤a≤1, Ma=Co, Ni), lithium cobaltate (LiCoO₂), lithium nickelate (LiNiO₂), lithium manganate having a spinel structure (LiMn₂O₄), a composite metal oxide represented by the general formula: LiNiₓCo_{y}Mn₂O₂ (x+y+z=1, 0≤x≤1, 0≤y≤1, 0≤z≤1), a lithium vanadium compound (LiV₂O₅), olivine type LiMbPO₄ (here, Mb represents one or more kinds of elements selected from Co, Ni, Mn, Fe, Mg, Nb, Ti, Al, and Zr), lithium vanadium phosphate (Li₃V₂(PO₄)₃ or LiVOPO₄), a Li-excess solid solution-based positive electrode represented by Li₂MnO₃—LiMcO₂ (Mc=Mn, Co, Ni), lithium titanate (Li₄Ti₅O₁₂), titanium oxide (TiO₂), and a composite metal oxide represented by Li₈NiₜCoᵤAlᵥO₂ (0.9<s<1.3, 0.9<t+u+v<1.1).

In addition, a part of each element constituting these positive electrode active materials may be substituted with a hetero element, and the compositional ratio of these positive electrode active materials may deviate from the stoichiometric composition.

The conductive auxiliary agent is not particularly limited as long as it improves the electronic conductivity in the positive electrode active material layer 12, and any publicly known conductive auxiliary agent can be used. Examples of the conductive auxiliary agent include a carbon-based material such as graphite, carbon black, graphene, or a carbon nanotube, a metal such as gold, platinum, silver, palladium, aluminum, copper, nickel, stainless steel, or iron, a conductive oxide such as ITO, and a mixture thereof. The conductive auxiliary agent may be in the form of each of powder and fiber.

The binding material bonds the positive electrode current collector layer 11 and the positive electrode active material layer 12 to each other, bonds the positive electrode active material layer 12 and the solid electrolyte layer 3 to each other, and bonds the various materials constituting the positive electrode active material layer 12 to each other.

The binding material can be used within a range that does not impair the function of the positive electrode active material layer 12. In a case where a binding material is not necessary, it may not be contained in the positive electrode active material layer 12. The content of the binding material in the positive electrode active material layer 12 is, for example, 0.5% by volume or more and 30% by volume or less of the positive electrode active material layer. In a case where the content of the binding material is sufficiently small, the resistance of the positive electrode active material layer 12 becomes sufficiently low. Here, the volume percentage (% by volume) is substantially equal to, for example, an area percentage in a cross section, which is measured by a scanning electron microscope. The area ratio in a cross section, which is measured by a scanning electron microscope, can be regarded as the volume ratio as it is.

The binding material may be any binding material that is capable of carrying out the above-described bonding. For example, a fluororesin such as polyvinylidene fluoride (PVDF) or polytetrafluoroethylene (PTFE) is an example of the binding material. In addition, the binding material may be, for example, cellulose, styrene-butadiene rubber, ethylene-propylene rubber, a polyimide resin, or a polyamide-imide resin. In addition, the binding material may also be a conductive polymer having electronic conductivity, or an ion conductive polymer having ionic conductivity. An example of the conductive polymer having electronic conductivity is polyacetylene. The ion conductive polymer having ionic conductivity is, for example, a composite ion conductive polymer formed from a monomer of a polymeric compound (a polyether-based polymer compound such as polyethylene oxide or polypropylene oxide, or polyphosphazene) and a lithium salt such as LiClO₄, LiBF₄, and LiPF₆, or an alkali metal salt mainly composed of lithium.

FIG. 4 shows an example in which the positive electrode 1 consists of the positive electrode current collector layer 11 and the positive electrode active material layer 12; however, the positive electrode 1 is not limited to this case. For example, the positive electrode 1 may be a single layer in which a positive electrode current collector and a positive electrode active material are mixed.

### “Negative Electrode”

The number of layers of the negative electrode 2 in the laminated body 10 does not matter. The negative electrode 2 may be singular or plural. The total of the number of layers of the positive electrode 1 and the number of layers of the negative electrode 2 in the laminated body 10 is, for example, three or more.

Each negative electrode 2 extends in the xy plane. The first end of each negative electrode 2 is connected to the negative electrode terminal 90 on the second surface S2 of the laminated body 10. The first surface S1 and the second surface S2 are different surfaces of the laminated body 10. For example, the first surface S1 and the second surface S2 face each other. The second end of each negative electrode 2 is exposed to the void 7. The second end of each negative electrode 2 faces the columnar body 6 with the void 7 being sandwiched between the second end and the columnar body 6.

The thickness of the negative electrode 2 is, for example, 2.5 times or more with respect to the thickness of the solid electrolyte layer 3. The thickness of the negative electrode 2 is, for example, 10 μm or more.

As shown in FIG. 4, the negative electrode 2 has, for example, a negative electrode current collector layer 21 and a negative electrode active material layer 22.

The negative electrode current collector layer 21 contains, for example, a highly conductive material. For the negative electrode current collector layer 21, for example, the same material as the material of the positive electrode current collector layer 11 can be used. The negative electrode current collector layer 21 is made of, for example, Ag or an AgPd alloy.

The negative electrode active material layer 22 is formed on one surface or both surfaces of the negative electrode current collector layer 21. The negative electrode active material layer 22 contains a negative electrode active material. The negative electrode active material layer 22 may contain a conductive auxiliary agent, a binding material, and a solid electrolyte described below.

The negative electrode active material is a compound capable of absorbing and releasing ions. The negative electrode active material is a compound that exhibits a lower potential than the positive electrode active material. For the negative electrode active material, the same material as the material of the positive electrode active material can be used. The negative electrode active material and the positive electrode active material, which are used in the all-solid state battery 100, are determined in consideration of the potential of the negative electrode active material and the potential of the positive electrode active material. Negative electrode active material includes, for example, Li₄Ti₅O₁₂, LiTiO₂, Li₂TiO₃, Li₂TiSiO₅, and a mixture of these.

The conductive auxiliary agent improves the electronic conductivity of the negative electrode active material layer 22. For the conductive auxiliary agent, the same material as the material of the positive electrode active material layer 12 can be used.

The binding material bonds the negative electrode current collector layer 21 and the negative electrode active material layer 22 to each other, bonds the negative electrode active material layer 22 and the solid electrolyte layer 3 to each other, and bonds the various materials constituting the negative electrode active material layer 22 to each other. For the binding material, the same material as the material of the positive electrode active material layer 12 can be used. The content rate of the binding material can be the same as the content rate of the positive electrode active material layer 12. In a case where a binding material is not necessary, it may not be contained in the negative electrode current collector layer 21.

FIG. 4 shows an example in which the negative electrode 2 consists of the negative electrode current collector layer 21 and the negative electrode active material layer 22; however, the negative electrode 2 is not limited to this case. For example, the negative electrode 2 may be a single layer in which a negative electrode current collector and a negative electrode active material are mixed.

### “Solid Electrolyte Layer”

The solid electrolyte layer 3 is present between the positive electrode 1 and the negative electrode 2. The solid electrolyte layer 3 contains a solid electrolyte. The solid electrolyte is a substance that can move ions by an externally applied electric field. For example, the solid electrolyte layer 3 conducts lithium ions and inhibits the movement of electrons. The solid electrolyte layer 3 is, for example, a sintered body obtained by sintering.

For the solid electrolyte layer 3, it is preferable to use a substance having low electronic conductivity and high lithium ion conductivity. For example, the solid electrolyte layer 3 includes a perovskite type compound such as La_{0.5}Li_{0.5}TiO₃, a LISICON type compound such as Li₁₄Zn(GeO₄)₄, a garnet type compound such as Li₇La₃Zr₂O₁₂, a NASICON type compound such as LiZr₂(PO₄)₃, Li_{1.3}Al_{0.3}Ti_{1.7}(PO₄)₃, Li_{1.5}Al_{0.5}Ge_{1.5}(PO₄)₃, a thio-LISICON type compounds such as Li_{3.25}Ge_{0.25}P_{0.75}S₄, or Li₃PS₄, a glass compound such as Li₂S—P₂S₅ or Li₂O—V₂O₅—SiO₂, and a phosphate compounds such as Li₃PO₄, Li_{3.5}Si_{0.5}P_{0.5}O₄, or Li_{2.9}PO_{3.3}N_{0.46}.

The solid electrolyte layer 3 contains, for example, a solid electrolyte having a γ-Li₃PO₄ type crystal structure. The solid electrolyte having a γ-Li₃PO₄ type crystal structure has excellent ionic conductivity. Examples of the solid electrolytes include Li₃₊ₓSiₓP₁₋ₓO₄, Li₃₊ₓSiₓV₁₋ₓO₄, Li₃₊ₓGeₓP₁₋ₓO₄, and Li₃₊ₓGeₓV₁₋ₓO₄, and Li₃₊ₓSiₓP₁₋ₓO₄ is preferable. x satisfies 0.4≤x≤0.8. In addition, the solid electrolyte may also be a ternary lithium oxide containing Si, V, and Ge.

### “Columnar Body”

The columnar body 4 is present in the same layer as that of the positive electrode 1. The columnar body 4 is an example of a first columnar body. The columnar body 4 is located at a position spaced apart from the positive electrode 1 with the void 5 being sandwiched between the columnar body 4 and the positive electrode 1. The columnar body 4 is located at a position shifted in the x direction from the positive electrode 1 with the void 5 being sandwiched between the columnar body 4 and the positive electrode 1. The columnar body 4 extends in the xy plane. The columnar body 4 is present between the positive electrode 1 and the negative electrode terminal 90 in the x direction. A first side surface of the columnar body 4 in the x direction is exposed to the void 5. A second side surface of the columnar body 4 in the x direction is in contact with, for example, the negative electrode terminal 90. The second side surface of the columnar body 4 in the x direction may be spaced apart from, for example, the negative electrode terminal 90. There may be a void between the columnar body 4 and the negative electrode terminal 90.

A third side surface of the columnar body 4 in the y direction is exposed, for example, at the third surface S3 of the laminated body 10, and a fourth side surface of the columnar body 4 in the y direction is exposed, for example, at the fourth surface of the laminated body 10. The columnar body 4 extends, for example, in the y direction from the third surface S3 to the fourth surface S4 of the laminated body 10. The columnar body 4 supports the solid electrolyte layers 3, which are adjacent to across the positive electrode 1.

As shown in FIG. 4, the columnar body 4 has, for example, a first layer 41 and a second layer 42. The second layer 42 is formed on one surface or both surfaces of the first layer 41. For example, the second layer 42 sandwiches the first layer 41 in the z direction. The first layer 41 is made of, for example, the same material as the material of the positive electrode current collector layer 11. The second layer 42 is made of, for example, the same material as the material of the positive electrode active material layer 12. The columnar body 4 has, for example, the same layer configuration as the positive electrode 1. For example, the second layer 42 is made of the same material and has the same thickness as the positive electrode active material layer 12. For example, the first layer 41 is made of the same material and has the same thickness as the positive electrode current collector layer 11.

The thickness of the columnar body 4 is, for example, 2.5 times or more with respect to the thickness of the solid electrolyte layer 3. The thickness of the columnar body 4 is, for example, 10 μm or more.

The void 5 is present between the positive electrode 1 and the columnar body 4 in the same layer as that of the positive electrode 1. The void 5 is exposed, for example, on both the third surface S3 and the fourth surface S4 of the laminated body 10 and extends from the third surface S3 to the fourth surface S4. The inside of the void 5 may be vacuumed, may be filled with a gas, or may be filled with a liquid.

The void 5 adjacent to each other in the z direction are at least partially overlapped, for example, in a case of being viewed from the z direction. For example, the first void 5A and the second void 5B are at least partially overlapped in a case of being viewed from the z direction. For example, in a case of being viewed from the z direction, 80% or more of the first void 5A is overlapped with the second void 5B. The first void 5A is a void 5 present in the same layer as that of the first positive electrode 1A. The first positive electrode 1A is one of the positive electrodes 1 in the laminated body 10. The second void 5B is a void 5 present in the same layer as that of the second positive electrode 1B. The second positive electrode 1B is a positive electrode 1 in the laminated body 10, which is adjacent to the first positive electrode 1A in the z direction.

In addition, in a case where the number of positive electrodes 1 is three or more, each of the void 5 present in the same plane as each of the positive electrodes 1 may be at least partially overlapped with all of the other void 5 in a case of being viewed from the z direction. In addition, for example, 80% or more of the first void 5A may be overlapped with all of the other void 5 in a case of being viewed from the z direction.

The columnar body 6 is present in the same layer as that of the negative electrode 2. The columnar body 6 is an example of a second columnar body. The columnar body 6 is located at a position spaced apart from the negative electrode 2 with the void 7 being sandwiched between the columnar body 6 and the negative electrode 2. The columnar body 6 is located at a position shifted in the x direction from the negative electrode 2 with the void 7 being sandwiched between the columnar body 6 and the negative electrode 2. The columnar body 6 extends in the xy plane. The columnar body 6 is present between the negative electrode 2 and the positive electrode terminal 80 in the x direction. A first side surface of the columnar body 6 in the x direction is exposed to the void 7. A second side surface of the columnar body 6 in the x direction is in contact with, for example, the positive electrode terminal 80. The second side surface of the columnar body 6 in the x direction may be spaced apart from, for example, the positive electrode terminal 80. There may be a void between the columnar body 6 and the positive electrode terminal 80.

A third side surface of the columnar body 6 in the y direction is exposed, for example, at the third surface S3 of the laminated body 10, and a fourth side surface of the columnar body 6 in the y direction is exposed, for example, at the fourth surface of the laminated body 10. The columnar body 6 extends, for example, in the y direction from the third surface S3 to the fourth surface S4 of the laminated body 10. The columnar body 6 supports the solid electrolyte layers 3, which are adjacent to across the negative electrode 2.

As shown in FIG. 4, the columnar body 6 has, for example, a first layer 61 and a second layer 62. The second layer 62 is formed on one surface or both surfaces of the first layer 61. For example, the second layers 62 sandwiches the first layer 61 in the z direction. The first layer 61 is made of, for example, the same material as the material of the negative electrode current collector layer 21. The second layer 62 is made of, for example, the same material as the material of the negative electrode active material layer 22. The columnar body 6 has, for example, the same layer configuration as the negative electrode 2. For example, the second layer 62 is made of the same material and has the same thickness as the negative electrode active material layer 22. For example, the first layer 61 is made of the same material and has the same thickness as the negative electrode current collector layer 21.

The thickness of the columnar body 6 is, for example, 2.5 times or more with respect to the thickness of the solid electrolyte layer 3. The thickness of the columnar body 6 is, for example, 10 μm or more.

The void 7 is present between the negative electrode 2 and the columnar body 6 in the same layer as that of the negative electrode 2. The void 7 is exposed, for example, on both the third surface S3 and the fourth surface S4 of the laminated body 10 and extends from the third surface S3 to the fourth surface S4. The inside of the void 7 may be vacuumed, may be filled with a gas, or may be filled with a liquid.

The void 7 adjacent to each other in the z direction are at least partially overlapped, for example, in a case of being viewed from the z direction. For example, the first void 7A and the second void 7B are at least partially overlapped in a case of being viewed from the z direction. For example, in a case of being viewed from the z direction, 80% or more of the first void 7A is overlapped with the second void 7B. The first void 7A is a void 7 present in the same layer as that of the first negative electrode 2A. The first negative electrode 2A is one of the negative electrodes 2 in the laminated body 10. The second void 7B is a void 7 present in the same layer as that of the second negative electrode 2B. The second negative electrode 2B is the negative electrode 2 of the laminated body 10, which is adjacent to the first negative electrode 2A in the z direction.

In addition, in a case where the number of negative electrodes 2 is three or more, each of the void 7 present in the same plane as each of the negative electrodes 2 may be at least partially overlapped with all of the other void 7 in a case of being viewed from the z direction. In addition, for example, 80% or more of the first void 7A may be overlapped with all of the other void 7 in a case of being viewed from the z direction.

### <Positive Electrode Terminal>

The positive electrode terminal 80 is in contact with the first surface S1 of the laminated body 10. The positive electrode terminal 80 covers the first surface S1 of the laminated body 10. A part of the positive electrode terminal 80 may extend around to a surface adjacent to the first surface S1. The positive electrode terminal 80 may be in contact with the first surface S1 and surfaces adjacent to the first surface (the third surface and the fourth surface). For example, the positive electrode terminal 80 may cover a part of the third surface S3 of the laminated body 10 and a part of the fourth surface S4 of the laminated body 10. The positive electrode terminal 80 covering the third surface S3 and the fourth surface S4 is not in contact with each of the negative electrodes 2. The positive electrode terminal 80 contains a material having conductivity. The positive electrode terminal 80 may include, for example, the same material as the material of the positive electrode current collector layer 11. The positive electrode terminal 80 serves to carry out electrical conduction between the laminated body 10 and an external pad.

### <Negative Electrode Terminal>

The negative electrode terminal 90 is in contact with the second surface S2 of the laminated body 10. The negative electrode terminal 90 covers the second surface S2 of the laminated body 10. A part of the negative electrode terminal 90 may extend around to a surface adjacent to the second surface S2. The negative electrode terminal 90 may be in contact with the second surface S2 and surfaces adjacent to the second surface (the third surface and the fourth surface). For example, the negative electrode terminal 90 may cover a part of the third surface S3 of the laminated body 10 and a part of the fourth surface S4 of the laminated body 10. The negative electrode terminal 90 covering the third surface S3 and the fourth surface S4 is not in contact with each of the positive electrodes 1. The negative electrode terminal 90 contains a material having conductivity. The negative electrode terminal 90 may include, for example, the same material as the material of the negative electrode current collector layer 21. The negative electrode terminal 90 serves to carry out electrical conduction between the laminated body 10 and an external pad.

“Manufacturing Method for all-Solid State Battery”

A manufacturing method for the all-solid state battery 100 will be described. First, the laminated body 10 is produced. The laminated body 10 is produced by, for example, a simultaneous sintering method or a sequential sintering method.

The simultaneous sintering method is a method in which materials for forming each layer are laminated and then sintered together at once to produce the laminated body 10. The sequential sintering method is a method in which sintering is carried out every time after each layer is formed. The simultaneous sintering method makes it possible to produce the laminated body 10 with few steps as compared with the sequential sintering method. In addition, the laminated body 10 produced by the simultaneous sintering method is denser than the laminated body 10 produced by the sequential sintering method. Hereinafter, an example in which the simultaneous sintering method is used will be described.

First, the materials for the positive electrode current collector layer 11, the positive electrode active material layer 12, the solid electrolyte layer 3, the negative electrode active material layer 22, and the negative electrode current collector layer 21, which constitute the laminated body 10, are made into a paste. The method for making each material into a paste is not particularly limited, and for example, a method in which a powder of each material is mixed with a vehicle to obtain a paste is used. Here, the vehicle is a general term for a medium in a liquid phase. The vehicle contains a solvent and a binder.

Next, a green sheet is produced. The green sheet is obtained by applying a paste produced for each material onto a base material such as a PET (polyethylene terephthalate) film, carrying out drying as necessary, and then peeling off the base material. The coating method for the paste is not particularly limited, and a publicly known method such as screen printing, coating, transfer, or doctor blade can be used.

The first layer 41 of the columnar body 4 can be formed at the same time as the positive electrode current collector layer 11 is coated. The second layer 42 of the columnar body 4 can be formed at the same time as the positive electrode active material layer 12 is coated. In a case where a portion that will serve as the void 5 is masked and then the paste for the positive electrode 1 is applied, the columnar body 4 is formed. In addition, the portion that will serve as the void 5 may be filled with a sacrificial material that sublimes by heating. In a case where the laminated body is sintered, the sacrificial material sublimes, and the void 5 is formed. The sacrificial material may be, for example, the same material as the material of the binder.

The first layer 61 of the columnar body 6 can be formed at the same time as the negative electrode current collector layer 21 is coated. The second layer 62 of the columnar body 6 is formed at the same time as the negative electrode active material layer 22 is coated. In a case where a portion that will serve as the void 7 is masked and then the paste for the negative electrode 2 is applied, the columnar body 6 is formed. In addition, the portion that will serve as the void 7 may be filled with a sacrificial material that sublimes by heating. In a case where the laminated body is sintered, the sacrificial material sublimes, and the void 7 is formed. The sacrificial material may be, for example, the same material as the material of the binder.

Next, the green sheet prepared for each material is stacked in a desired order and with a desired number of layers to prepare a laminated sheet. In a case of laminating the green sheet, alignment and cutting are carried out as necessary. For example, in a case of producing a parallel or serial-parallel battery, alignment is carried out so that the end surface of the positive electrode current collector layer 11 and the end surface of the negative electrode current collector layer 21 do not coincide with each other, and each green sheet is stacked.

The laminated sheet may be produced by using a method of producing a positive electrode unit and a negative electrode unit and laminating these units. The positive electrode unit is a laminated sheet in which the solid electrolyte layer 3, the positive electrode active material layer 12, the positive electrode current collector layer 11, and the positive electrode active material layer 12 are laminated in this order. The first layer 41 is formed in the same plane as the positive electrode current collector layer 11, and the second layer 42 is formed in the same plane as the positive electrode active material layer 12. The negative electrode unit is a laminated sheet in which the solid electrolyte layer 3, the negative electrode active material layer 22, the negative electrode current collector layer 21, and the negative electrode active material layer 22 are laminated in this order. The first layer 61 is formed in the same plane as the negative electrode current collector layer 21, and the second layer 62 is formed in the same plane as the negative electrode active material layer 22. The lamination is carried out so that the solid electrolyte layer 3 of the positive electrode unit and the negative electrode active material layer 22 of the negative electrode unit face each other, or the positive electrode active material layer 12 of the positive electrode unit and the solid electrolyte layer 3 of the negative electrode unit face each other.

Next, the produced laminated sheet is subjected to collective pressurization to increase the adherence between the layers. The pressurization can be carried out, for example, by a die press, a warm isostatic press (WIP), a cold isostatic press (CIP), an isostatic press, or the like. The pressurization is preferably carried out while carrying out heating. The heating temperature during compression bonding is, for example, 40° C. to 95° C. Next, the laminated body after pressurization is cut into chips using a dicing device. Then, the chips are subjected to a binder removal treatment and sintering to obtain a laminated body 10 consisting of a sintered body.

The binder removal treatment is carried out as a separate step from the sintering step. In a case where the binder removal step is carried out, the binder component contained in the chips undergoes heating decomposition before the sintering step, and the binder component can be prevented from being rapidly decomposed in the sintering step. In the binder removal step, for example, the laminated body is heated in an air atmosphere at a temperature of 300° C. or higher and 800° C. or lower for a period of 0.1 hours or more and 10 hours or less. The atmosphere in the binder removal step is in an oxygen partial pressure environment in which the materials constituting the positive electrode, the negative electrode, and the solid electrolyte do not or hardly undergo oxidation and reduction. The type of gas in the binder removal step can be selected in any desired manner so that the materials constituting the positive electrode, negative electrode, and solid electrolyte do not react with the atmospheric gas. For example, the binder removal step may be carried out in a nitrogen atmosphere, an argon atmosphere, a nitrogen/hydrogen mixed atmosphere, a water vapor atmosphere, or an atmosphere obtained by mixing these atmospheres.

The sintering step is carried out, for example, by placing the chip on a ceramic base. The sintering is carried out, for example, by heating the laminated body to 600° C. to 1,000° C. in a nitrogen atmosphere. The sintering time is set to, for example, 0.1 hours to 3 hours. The atmosphere in the sintering step is in an oxygen partial pressure environment in which the materials constituting the positive electrode, the negative electrode, and the solid electrolyte do not or hardly undergo oxidation and reduction. The type of gas in the sintering step can be selected in any desired manner so that the materials constituting the positive electrode, negative electrode, and solid electrolyte do not react with the atmospheric gas. For example, the sintering step may be carried out in a nitrogen atmosphere, an argon atmosphere, a nitrogen/hydrogen mixed atmosphere, a water vapor atmosphere, or an atmosphere obtained by mixing these atmospheres.

In addition, the sintered laminated body 10 may be placed in a cylinder type container together with a polishing material such as alumina and may be subjected to barrel polishing. This allows the corners of the laminated body 10 to be chamfered. The polishing may be carried out by using sand blasting. Sand blasting is preferable because it is possible to remove only specific portions.

The positive electrode terminal 80 is formed on the first surface S1 of the produced laminated body 10, and the negative electrode terminal 90 is formed on the second surface S2. The positive electrode terminal 80 and the negative electrode terminal 90 can be formed by using means such as a sputtering method, a dipping method, a screen printing method, or a spray coating method. Through such steps as described above, the all-solid state battery 100 can be produced. In a case where the positive electrode terminal 80 and the negative electrode terminal 90 are formed only on predetermined portions, masking is carried out with tape or the like, and then the above-described treatment is carried out.

The all-solid state battery 100 according to the present embodiment has the columnar body 4 and the columnar body 6. The columnar body 4 and the columnar body 6 support the solid electrolyte layers 3 adjacent to the columnar body 4 or the columnar body 6. The columnar body 4 and the columnar body 6 can suppress the concentration of stress on the solid electrolyte layer 3 during the pressurization and the sintering in the manufacturing. In addition, in a case where the all-solid state battery 100 has the void 5 and the void 7, the void 5 and the void 7 alleviate the stress applied to the inside of the all-solid state battery 100. Therefore, even in a case where the positive electrode active material layer 12 and the negative electrode active material layer 22 undergo a volume change during charging and discharging of the all-solid state battery 100 and then distortion occurs in the inside of the all-solid state battery 100, it is possible to suppress the occurrence of cracking in the inside of the all-solid state battery 100.

As described above, the embodiments of the present invention have been described in detail with reference to the drawings. However, Each of the configurations and the combination thereof in each embodiment are examples, and additions, omissions, substitutions, and other modifications of the configuration can be made without departing from the spirit of the present invention.

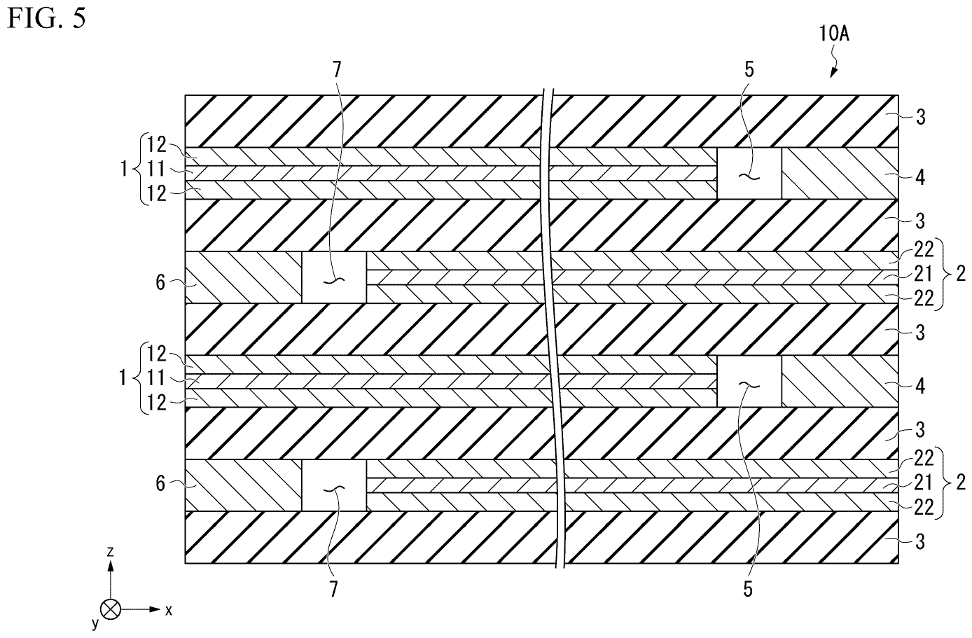

For example, FIG. 5 is a cross-sectional view of a laminated body 10A of an all-solid state battery according to a first modified example. The laminated body 10A differs from the laminated body 10 in the configurations of the columnar body 4 and the columnar body 6. The columnar body 4 and the columnar body 6 in the laminated body 10A consist of a single layer. Although an example in which both the columnar body 4 and the columnar body 6 are a single layer is shown in FIG. 5, only any one of the columnar body 4 and the columnar body 6 may be a single layer. Even in a case where the columnar body 4 or the columnar body 6 are a single layer, they can support the adjacent solid electrolyte layers 3, and thus the same effect as that of the laminated body 10 is exhibited. The materials constituting the single-layered columnar body 4 and the single-layered columnar body 6 do not particularly matter. For example, the single-layered columnar body 4 and the single-layered columnar body 6 contain the same material as the material of the solid electrolyte that constitutes the solid electrolyte layer 3.

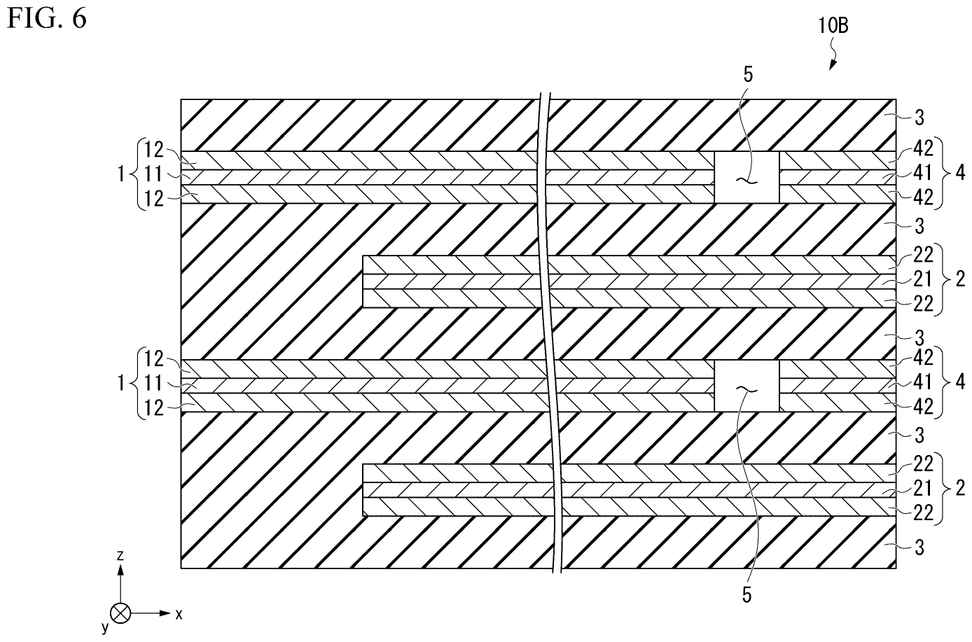

In addition, for example, FIG. 6 is a cross-sectional view of a laminated body 10B of an all-solid state battery according to a second modified example. The laminated body 10B differs from the laminated body 10 in that the columnar body 6 and the void 7 are not present. That is, the laminated body 10B has the columnar body 4 and the void 5 only in the same layer as that of the positive electrode 1. In the laminated body 10B, the portions where the columnar body 6 and the void 7 of the laminated body 10 were present are filled with the same solid electrolyte as that of the solid electrolyte layer 3. The columnar body 4 may be a single layer as in the first modified example.

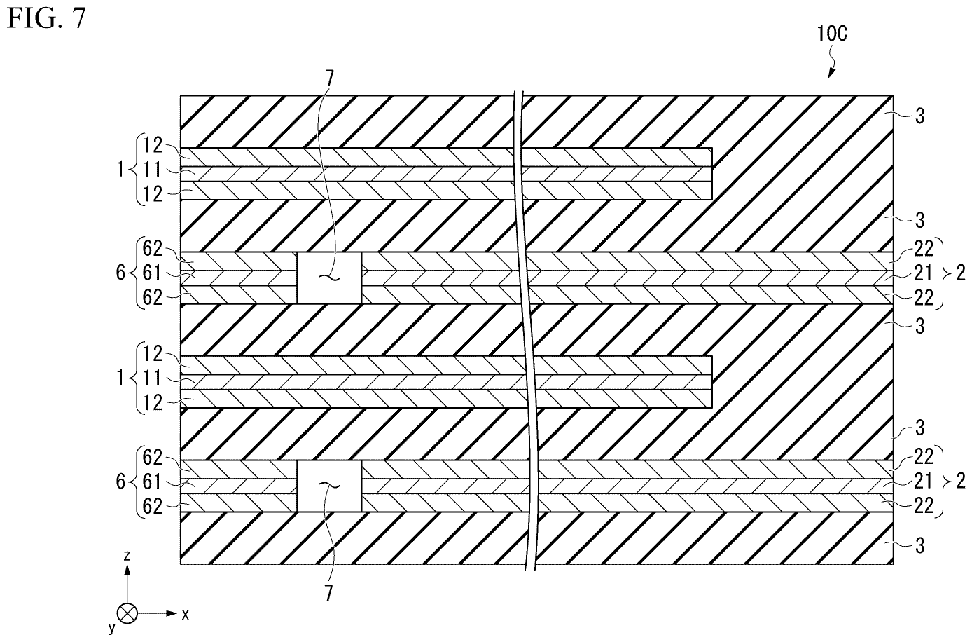

In addition, for example, FIG. 7 is a cross-sectional view of a laminated body 10C of an all-solid state battery according to a third modified example. The laminated body 10C differs from the laminated body 10 in that the columnar body 4 and the void 5 are not present. That is, the laminated body 10C has the columnar body 6 and the void 7 only in the same layer as that of the negative electrode 2. In this case, the columnar body 6 is an example of the first columnar body. In the laminated body 10C, the portions where the columnar body 4 and the void 5 of the laminated body 10 were present are filled with the same solid electrolyte as that of the solid electrolyte layer 3. The columnar body 6 may be a single layer as in the first modified example.

As shown in the second modified example and the third modified example, even in a case where the columnar body and the void are present only in any one of the layers of the positive electrode 1 and the negative electrode 2, the same effect as that of the laminated body 10 is exhibited.

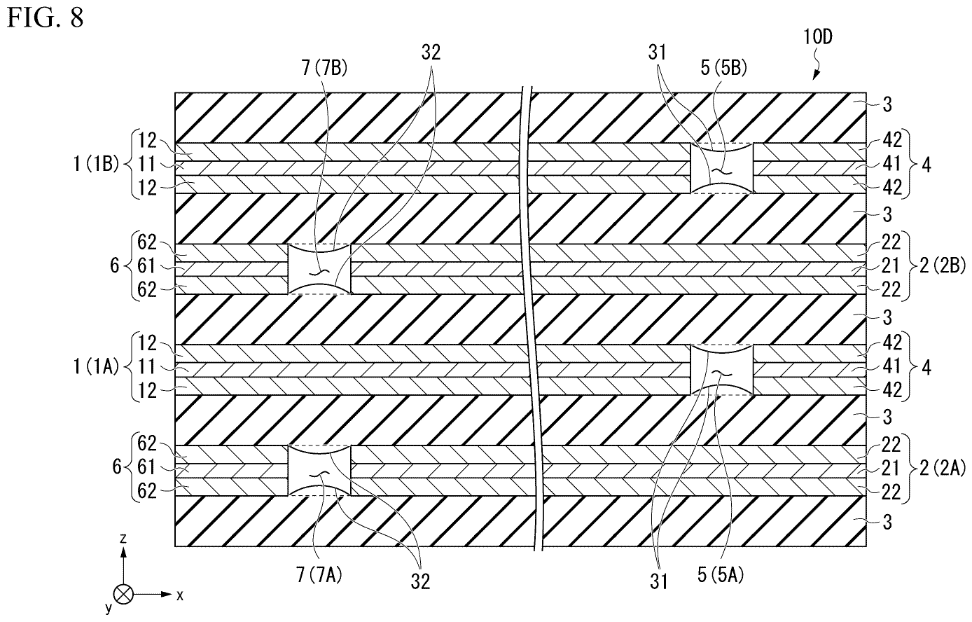

In addition, for example, FIG. 8 is a cross-sectional view of a laminated body 10D of an all-solid state battery according to a fourth modified example. The laminated body 10D differs from the laminated body 10 in that it includes a region 31 containing a solid electrolyte that constitutes the solid electrolyte layer 3, between the positive electrode 1 and the columnar body 4 in the same layer as that of the positive electrode 1, and includes a region 32 containing a solid electrolyte that constitutes the solid electrolyte layer 3, between the negative electrode 2 and the columnar body 6 in the same layer as that of the negative electrode 2. The region 31 is a portion in which a part of the solid electrolyte layer 3 protrudes into the void 5. The region 32 is a portion in which a part of the solid electrolyte layer 3 protrudes into the void 7. Since a part of the solid electrolyte layer 3 protrudes into the void 5 and the void 7, stress applied within the solid electrolyte layer 3 can be alleviated.

In the laminated body 10D, it is not necessary that both the region 31 and the region 32 are present, and only any one of them may be present. In the laminated body 10D, the columnar body 4 and the columnar body 6 may be a single layer. In addition, similarly to the second modified example and the third modified example, the laminated body 10D may not have any of the columnar body 4 or the columnar body 6.

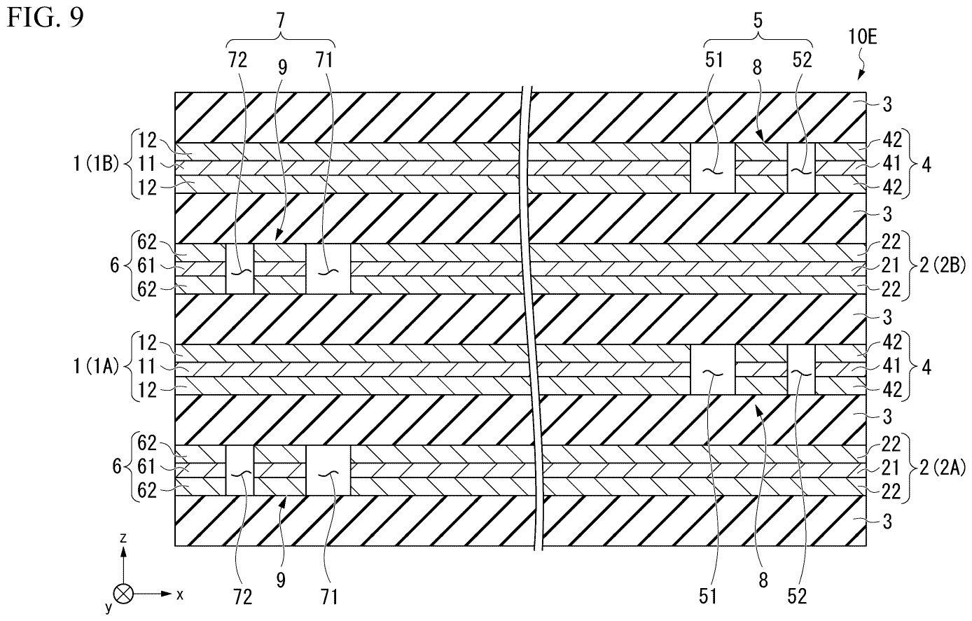

In addition, for example, FIG. 9 is a cross-sectional view of a laminated body 10E of an all-solid state battery according to a fifth modified example. The laminated body 10E differs from laminated body 10 in that it further includes a columnar body 8 between positive electrode 1 and columnar body 4 in the same layer as positive electrode 1, and further includes a columnar body 9 between negative electrode 2 and columnar body 6 in the same layer as negative electrode 2. The columnar body 8 and the columnar body 9 are examples of third columnar body.

The laminated body 10E has a plurality of columnar bodies in the same layer as that of the positive electrode 1 or the negative electrode 2. Although FIG. 9 shows an example in which there are two columnar bodies in the same layer, the number of columnar bodies may be three or more. In a case of having a plurality of columnar bodies in the layer, the force applied to each columnar body is dispersed. As a result, distortion is less likely to occur in the inside of the laminated body 10E.

The void 5 between the positive electrode 1 and the columnar body 4 is divided into a void 51 and a void 52 by the columnar body 8. The void 7 between the negative electrode 2 and the columnar body 6 is divided into a void 71 and a void 72 by the columnar body 9. The columnar body 8 may be a single layer or a laminated body of a plurality of layers. For example, the columnar body 8 has the same configuration as the columnar body 4. The columnar body 9 may be a single layer or a laminated body of a plurality of layers. For example, the columnar body 9 has the same configuration as the columnar body 6.

In the laminated body 10E, it is not necessary that both the columnar body 8 and the columnar body 9 are present, and only any one of them may be present. In the laminated body 10E, a layer having a plurality of columnar bodies in the layer, and a layer having one columnar body in the layer may be mixed. In addition, similarly to the second modified example and the third modified example, the laminated body 10E may not have a columnar body in the same layer as that of the positive electrode 1 or the negative electrode 2.

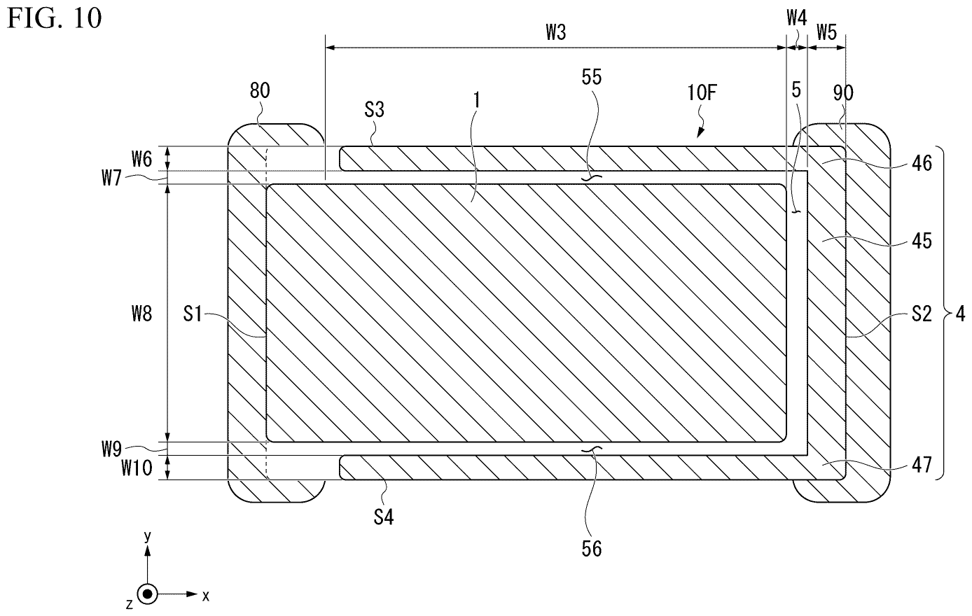

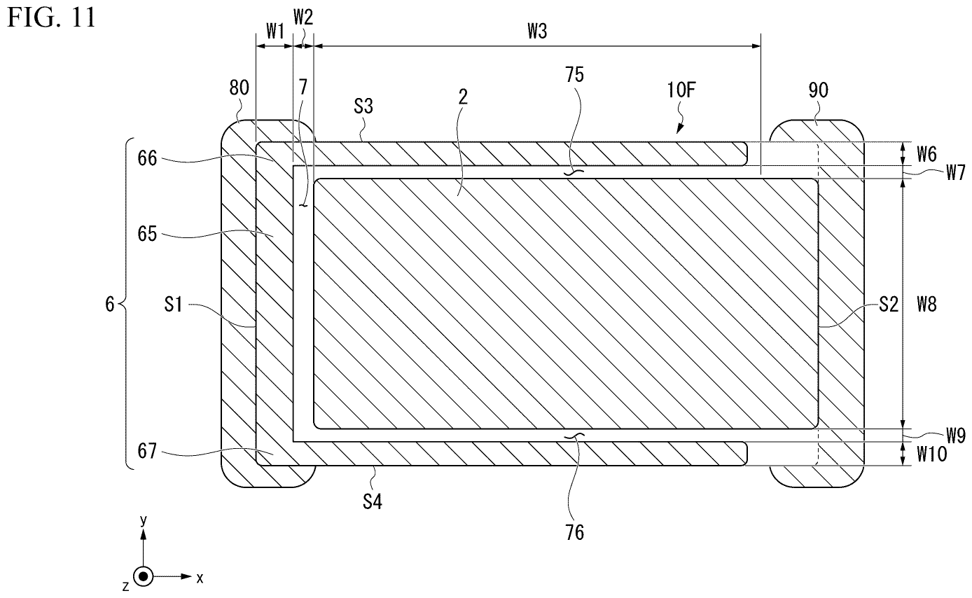

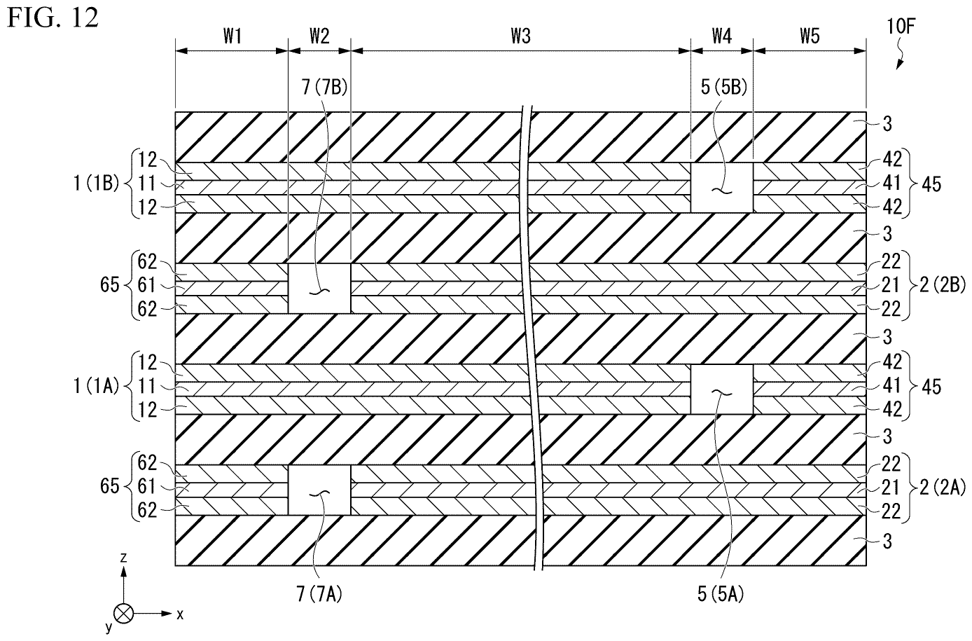

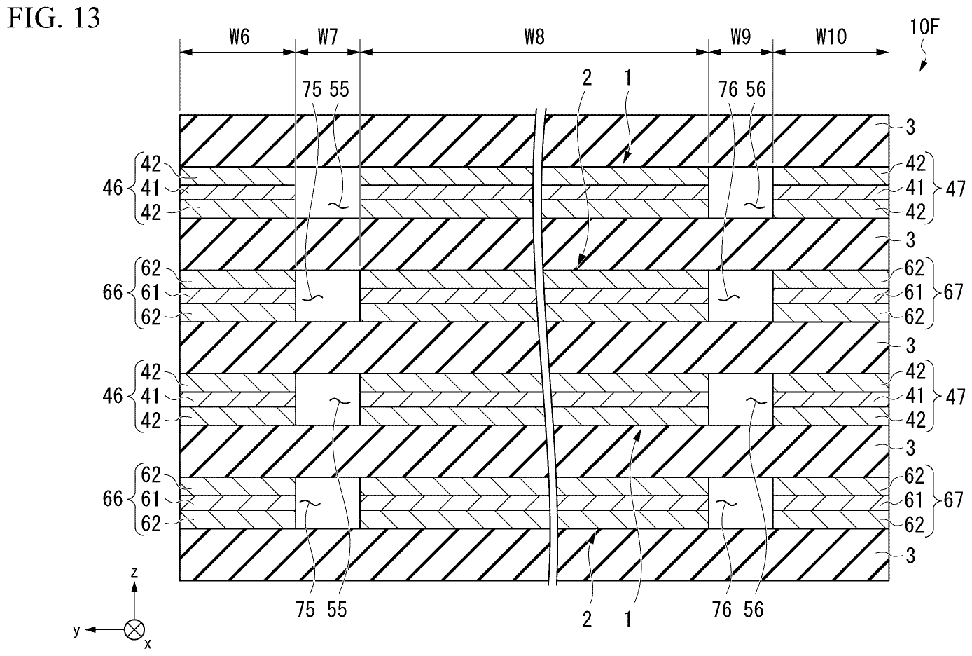

In addition, for example, FIG. 10 is a cross-sectional view that is obtained by cutting an all-solid state battery according to a sixth modified example along the positive electrode 1. FIG. 11 is a cross-sectional view that is obtained by cutting an all-solid state battery according to a sixth modified example along the negative electrode 2. FIG. 12 is a cross-sectional view obtained by cutting a laminated body 10F according to a sixth modified example along the xz plane. FIG. 13 is a cross-sectional view obtained by cutting a laminated body 10F according to a sixth modified example along the yz plane.

The columnar body 4 has a first portion 45, a second portion 46, and a third portion 47. The first portion 45 is located in the x direction of the positive electrode 1 with the void 5 being sandwiched between the first portion 45 and the positive electrode 1. The second portion 46 is located in the y direction of the positive electrode 1 with the void 55 being sandwiched between the second portion 46 and the positive electrode 1. The third portion 47 is located in the y direction of the positive electrode 1 with the void 56 being sandwiched between the third portion 47 and the positive electrode 1. The second portion 46 and the third portion 47 sandwich the positive electrode 1 in the y direction. A part of the columnar body 4 is located in the y direction of the positive electrode 1. Here, an example is shown, where the columnar body 4 in which the first portion 45, the second portion 46, and the third portion 47 are connected is formed; however, the first portion 45 and the second portion 46, and the first portion 45 and the third portion 47 may be separated. In a case where these are separated, the second portion 46 and third portion 47 are each an example of the fourth columnar body. Regarding the layer configuration, each of the first portion 45, the second portion 46, and the third portion 47 may be a single layer or may be a portion in which a plurality of layers are laminated.

The columnar body 6 has a first portion 65, a second portion 66, and a third portion 67. The first portion 65 is located in the y direction of the negative electrode 2 with the void 7 being sandwiched between the first portion 65 and the negative electrode 2. The second portion 66 is located in the y direction of the negative electrode 2 with the void 75 being sandwiched between the second portion 66 and the negative electrode 2. The third portion 67 is located in the y direction of the negative electrode 2 with the void 76 being sandwiched between the third portion 67 and the negative electrode 2. The second portion 66 and the third portion 67 sandwich the negative electrode 2 in the y direction. A part of the columnar body 6 is located in the y direction of the negative electrode 2. Here, an example is shown, where the columnar body 6 in which the first portion 65, the second portion 66, and the third portion 67 are connected is formed; however, the first portion 65 and the second portion 66, and the first portion 65 and the third portion 67 may be separated. In a case where these are separated, the second portion 66 and third portion 67 are examples of the fourth columnar body. Regarding the layer configuration, each of the first portion 65, the second portion 66, and the third portion 67 may be a single layer or may be a portion in which a plurality of layers are laminated.

A width of the first portion 65 of the columnar body 6 in the x direction is denoted as W1, a width of the void 7 in the x direction is denoted as W2, a width of a portion in the x direction, where the positive electrode 1 and the negative electrode 2 are overlapped in a case of being viewed from the z direction is denoted as W3, a width of the void 5 in the x direction is denoted as W4, and a width of the first portion 45 of the columnar body 4 in the x direction is denoted as W5. In this case, W2/W1 preferably satisfies 0.07≤W2/W1≤15.0, and more preferably satisfies 0.14≤W2/W1≤7.0. In addition, W4/W5 preferably satisfies 0.07≤W4/W5≤15.0, and more preferably satisfies 0.14≤W4/W5≤70. In a case where the width of the void in the x direction is broad as compared with the width of the columnar body in the x direction, the stress in association with a volume change during charging and discharging cannot be sufficiently alleviated, which increases the risk of the occurrence of cracking. In a case where the width of the void in the x direction is narrow as compared with the width of the columnar body in the x direction, the risk of the occurrence of a short circuit through the columnar body increases.

A width of the second portion 46 of the columnar body 4 in the y direction is denoted as W6, a width of each of the voids 55 and 75 in the y direction is denoted as W7, a width of a portion in the y direction, where the positive electrode 1 and the negative electrode 2 are overlapped in a case of being viewed from the z direction is denoted as W8, a width of each of the voids 56 and 76 in the y direction is denoted as W9, and a width of the third portion 47 of the columnar body 4 in the y direction is denoted as W10. In this case, W7/W6 preferably satisfies 0.07≤W7/W6≤15.0, and more preferably satisfies 0.14≤W7/W6≤7.0. In addition, W9/W10 preferably satisfies 0.07≤W9/W10≤15.0, and more preferably satisfies 0.14≤W9/W10≤70. In a case where the width of the void in the y direction is broad as compared with the width of the columnar body in the y direction, the stress in association with a volume change during charging and discharging cannot be sufficiently alleviated, which increases the risk of the occurrence of cracking. In a case where the width of the void in the y direction is narrow as compared with the width of the columnar body in the y direction, the risk of the occurrence of a short circuit through the columnar body increases.

In a case where a part of the columnar bodies 4 and 6 is present in the y direction of the positive electrode 1 and the negative electrode 2, the solid electrolyte layer 3 can be supported three-dimensionally, and the concentration of stress in the solid electrolyte layer 3 can be further suppressed during pressurization and sintering in the manufacturing. In addition, by having a void in the y direction of the positive electrode 1 and the negative electrode 2, which are included in the all-solid state battery, the stress applied to the inside of the all-solid state battery can be further alleviated.

Although several modified examples have been specifically described above, the characteristic configurations of the respective modified examples may be combined. In other words, the characteristic configurations of the respective modified examples may be combined to form another modified example.

### EXAMPLES

### Example 1

### (Production of Positive Electrode Paste)

The positive electrode current collector layer paste was produced using a powder obtained by mixing Ag, Pd, and LiCoO₂ in a ratio of 64:16:20 in terms of mass ratio. Ethyl cellulose and dihydroterpineol were added to this powder and mixed. Ethyl cellulose is a binder, and dihydroterpineol is a solvent.

The positive electrode active material layer paste was produced by adding ethyl cellulose and dihydroterpineol to LiCoO₂ and then mixing them.

### (Production of Solid Electrolyte Layer Paste)

The starting materials, Li₂CO₃, SiO₂, and Li₃PO₄, were mixed in a molar ratio of 2:1:1. The mixing was such that wet mixing was carried out for 16 hours using a ball mill with water as a dispersion medium. The mixture was preliminarily baked at 950° C. for 2 hours to produce Li_{3.5}Si_{0.5}P_{0.5}O₄. Then, 100 parts by mass of this preliminarily baked powder, 100 parts by mass of ethanol, and 200 parts by mass of toluene were added to a ball mill and subjected to wet mixing. Then, 16 parts by mass of a polyvinyl butyral-based binder and 4.8 parts by mass of benzyl butyl phthalate were further charged thereto and mixed to produce a solid electrolyte layer paste.

### (Production of Negative Electrode Paste)

The negative electrode paste was produced using a powder obtained by mixing Ag, Pd, and Li_{3.5}Si_{0.5}P_{0.5}O₄ in a ratio of 40:10:50 in terms of mass ratio. Ethyl cellulose and dihydroterpineol were added to this powder and mixed.

(Production of all-Solid State Battery)

Next, a positive electrode unit and a negative electrode unit were produced according to the following procedure. First, the positive electrode active material layer paste was subjected to printing on the above-described solid electrolyte layer sheet by using screen printing. Next, the positive electrode active material layer paste subjected to printing was dried at 80° C. for 5 minutes. Then, the positive electrode current collector layer paste was subjected to printing by using screen printing on the dried positive electrode active material layer paste. Next, the positive electrode current collector layer paste subjected to printing was then dried at 80° C. for 5 minutes. Then, the positive electrode active material layer paste was subjected to printing again on the dried positive electrode current collector layer paste by using screen printing, and then drying was carried out.

Then, in the same layer as that of the positive electrode current collector layer paste and the positive electrode active material paste, and at a position spaced apart from the positive electrode current collector layer paste and the positive electrode active material paste in the x direction, a solid electrolyte layer paste that would serve as a columnar body was subjected to printing, and then dried. Thereafter, the PET film was peeled off. In this manner, a positive electrode unit in which the lamination was carried out in the order of positive electrode active material layer/positive electrode current collector layer/positive electrode active material layer on the main surface of the solid electrolyte layer, and which had a columnar body made of the same material as the material of the solid electrolyte layer, was obtained.

In addition, a negative electrode unit in which a negative electrode was laminated on the main surface of the solid electrolyte layer was obtained according to the same procedure. The negative electrode unit has a columnar body made of the same material as the material of the solid electrolyte layer at a position spaced apart from the negative electrode in the x direction. The columnar body can be produced by subjecting a solid electrolyte layer paste that would serve as a columnar body to printing at a position spaced apart from the negative electrode paste in the x direction in the same layer as that of the negative electrode paste, and then carrying out drying. In the negative electrode of Example 1, the negative electrode current collector layer and the negative electrode active material layer are not separated, and AgPd functions as both the negative electrode active material and the negative electrode current collector.

Next, the solid electrolyte layer paste was subjected to printing and drying a plurality of times in a divided manner to produce a solid electrolyte unit.

Next, ten electrode units (five positive electrode units and five negative electrode units) were stacked alternately to sandwich the solid electrolyte unit. In this case, the individual units were shifted and then stacked so that the odd-numbered electrode units (positive electrode units) were exposed on the first surface S1 and the even-numbered electrode units (negative electrode units) were exposed on the second surface S2. Then, six solid electrolyte layer sheets were stacked on top of the stacked units. Thereafter, the resultant was sandwiched with SUS plates, and the individual units were bonded together by thermocompression bonding and then cut to produce a laminated chip. Thereafter, the laminated chip was subjected to simultaneous sintering to obtain a laminated body. The simultaneous sintering was carried out by increasing the temperature to a sintering temperature of 800° C. at a temperature rising rate of 200° C./hour in an air atmosphere, maintaining the temperature for 2 hours, and then carrying out natural cooling after sintering.

In the produced laminated body, the positive electrode had a thickness of 35 μm, the negative electrode had a thickness of 35 μm, and the solid electrolyte layer had a thickness of 14 μm. In addition, the thickness of the columnar body present in the same layer as that of the positive electrode was 35 μm, and the thickness of the columnar body present in the same layer as that of the negative electrode was also 35 μm.

Then, a positive electrode terminal and a negative electrode terminal were formed on the produced laminated body (battery base body). 100 samples were produced under the similar conditions. Then, the cycle characteristics of each sample were measured. In an environment of 25° C., carrying out constant current charging (CC charging) at a constant current of a 0.2 C rate until the battery voltage reaches 4.0 V, and then carrying out discharging (CC discharging) at a constant current of a 0.2 C rate until the battery voltage reaches 0 V were defined as one cycle of charging and discharging of the all-solid state battery. 100 cycles of this cycle were repeated, and the yield of samples having a capacity retention rate of 90% or more was determined. The capacity retention rate is determined by “capacity of the all-solid state battery at the 1st cycle”/“capacity of the all-solid state battery at the 100th cycle”×100.

### Examples 2 to 4

Examples 2 to 4 differ from Example 1 in that at least one of the layer configurations of the columnar body present in the same layer as that of the positive electrode and the columnar body present in the same layer as that of the negative electrode is different.

Example 2 differs from Example 1 in that the columnar body present in the same layer as that of the positive electrode has the same layer configuration as the positive electrode.

Example 3 differs from Example 1 in that the columnar body present in the same layer as that of the negative electrode has the same layer configuration as the negative electrode.

Example 4 differs from Example 1 in that the columnar body present in the same layer as that of the positive electrode has the same layer configuration as the positive electrode, and the columnar body present in the same layer as that of the negative electrode has the same layer configuration as the negative electrode. The other configurations were set to be the same as in Example 1, and then the yield of the samples was determined.

A columnar body having the same layer configuration as the positive electrode can be produced by, in a case of carrying out screen printing of the positive electrode current collector layer paste and the positive electrode active material layer paste, subjecting these pastes to printing at the same time at a position that will serve as a columnar part. A columnar body having the same layer configuration as the negative electrode can be produced by, in a case of carrying out screen printing of the negative electrode paste, subjecting the negative electrode paste to printing at the same time at a position that will serve as a columnar part.

### Examples 5 to 10

Examples 5 to 10 differ from Example 4 in that the thickness of the solid electrolyte layer was changed. The other configurations were set to be the same as in Example 4, and then the yield of the samples was determined. The thickness of the solid electrolyte layer in each example was set as follows.
Example 5: 4 μm
Example 6: 6 μm
Example 7: 8 μm
Example 8: 10 μm
Example 9: 18 μm
Example 10: 22 μm

### Examples 11 to 15

Examples 11 to 15 differ from Example 4 in that the number of electrode units used in producing the all-solid state battery was changed. The other configurations were set to be the same as in Example 4, and then the yield of the samples was determined. The total number of electrodes in the laminated body in each example was set as follows.
Example 11: 6 layers
Example 12: 20 layers
Example 13: 40 layers
Example 14: 80 layers
Example 15: 120 layers

### Examples 16 to 19

Examples 16 to 19 differ from Example 4 in that the thickness of the positive electrode was changed. The other configurations were set to be the same as in Example 4, and then the yield of the samples was determined. The thickness of the positive electrode in each example was set as follows.
Example 16: 2 μm
Example 17: 5 μm
Example 18: 10 μm
Example 19: 20 μm
Example 20: 50 μm

### Examples 20 to 25

Examples 20 to 25 differ from Example 4 in that the thickness of the negative electrode was changed. The other configurations were set to be the same as in Example 4, and then the yield of the samples was determined. The thickness of the negative electrode in each example was set as follows.
Example 20: 2 μm
Example 21: 5 μm
Example 22: 10 μm
Example 23: 20 μm
Example 24: 50 μm

### Comparative Example 1

Comparative Example 1 differs from Example 11 in that the columnar body was not produced. The other configurations were set to be the same as in Example 11, and then the yield of the samples was determined.

### Comparative Examples 2 to 7

Comparative Examples 2 to 7 differ from Comparative Example 1 in that the thickness of the solid electrolyte layer was changed. The other configurations were set to be the same as in Comparative Example 1, and then the yield of the samples was determined. The thickness of the solid electrolyte layer in each comparative example was set as follows.
Comparative Example 2: 18 μm
Comparative Example 3: 14 μm
Comparative Example 4: 10 μm
Comparative Example 5: 8 μm
Comparative Example 6: 6 μm
Comparative Example 7: 4 μm

### Comparative Examples 8 to 10

Comparative Examples 8 to 10 differ from Comparative Example 3 in that the number of electrode units used in producing the all-solid state battery was changed. The other configurations were set to be the same as in Comparative Example 3, and then the yield of the samples was determined. The total number of electrodes in the laminated body in each comparative example was set as follows.
Comparative Example 8: 6 layers
Comparative Example 9: 3 layers
Comparative Example 10: 2 layers

### Comparative Examples 11 to 15

Comparative Examples 11 to 15 differ from Comparative Example 3 in that the thickness of the positive electrode was changed. The other configurations were set to be the same as in Comparative Example 3, and then the yield of the samples was determined. The thickness of the positive electrode in each comparative example was set as follows.
Comparative Example 11: 2 μm
Comparative Example 12: 5 μm
Comparative Example 13: 10 μm
Comparative Example 14: 20 μm
Comparative Example 15: 50 μm

### Comparative Examples 16 to 20

Comparative Examples 16 to 20 differ from Comparative Example 3 in that the thickness of the negative electrode was changed. The other configurations were set to be the same as in Comparative Example 3, and then the yield of the samples was determined. The thickness of the negative electrode in each example was set as follows.
Comparative Example 16: 2 μm
Comparative Example 17: 5 μm
Comparative Example 18: 10 μm
Comparative Example 19: 20 μm
Comparative Example 20: 50 μm

The results of Examples 1 to 24 and Comparative Examples 1 to 20 are summarized in Table 1 to Table 4 below. In Tables 1 to 4, L1 is the thickness of the positive electrode, L2 is the thickness of the negative electrode, and L3 is the thickness of the solid electrolyte layer.

TABLE 1

| | | | | | | Solid | | | | Number of | |
|---|---|---|---|---|---|---|---|---|---|---|---|
| | Columnar body in same layer | | Columnar body in same layer | | | electro- | | | | laminations | |
| | as layer of positive electrode | | as layer of negative electrode | | Positive | lyte | Negative | | | of | |
| | Number | Material of | Number | Material of | electrode | layer | electrode | | | laminated | Yield |
| | of layers | columnar body | of layers | columnar body | (μm) | (μm) | (μm) | L1/L3 | L2/L3 | body | (%) |
| Example 1 | Single | Same as material of | Single | Same as material | 35 | 14 | 35 | 2.5 | 2.5 | 10 | 98 |
| | layer | solid electrolyte layer | layer | of solid | | | | | | | |
| | | | | electrolyte layer | | | | | | | |
| Example 2 | Three | Same as material of | Single | Same as material | 35 | 14 | 35 | 2.5 | 2.5 | 10 | 98 |
| | layers | three layers of positive | layer | of solid | | | | | | | |
| | | electrode | | electrolyte layer | | | | | | | |
| Example 3 | Single | Same as material of | Single | Same as negative | 35 | 14 | 35 | 2.5 | 2.5 | 10 | 98 |
| | layer | solid electrolyte layer | layer | electrode | | | | | | | |
| Example 4 | Three | Same as material of | Single | Same as negative | 35 | 14 | 35 | 2.5 | 2.5 | 10 | 99 |
| | layers | three layers of positive | layer | electrode | | | | | | | |
| | | electrode | | | | | | | | | |
| Example 5 | Three | Same as material of | Single | Same as negative | 35 | 4 | 35 | 8.8 | 8.8 | 10 | 92 |
| | layers | three layers of positive | layer | electrode | | | | | | | |
| | | electrode | | | | | | | | | |
| Example 6 | Three | Same as material of | Single | Same as negative | 35 | 6 | 35 | 5.8 | 5.8 | 10 | 94 |
| | layers | three layers of positive | layer | electrode | | | | | | | |
| | | electrode | | | | | | | | | |
| Example 7 | Three | Same as material of | Single | Same as negative | 35 | 8 | 35 | 4.4 | 4.4 | 10 | 95 |
| | layers | three layers of positive | layer | electrode | | | | | | | |
| | | electrode | | | | | | | | | |
| Example 8 | Three | Same as material of | Single | Same as negative | 35 | 10 | 35 | 3.5 | 3.5 | 10 | 97 |
| | layers | three layers of positive | layer | electrode | | | | | | | |
| | | electrode | | | | | | | | | |
| Example 9 | Three | Same as material of | Single | Same as negative | 35 | 18 | 35 | 1.9 | 1.9 | 10 | 99 |
| | layers | three layers of positive | layer | electrode | | | | | | | |
| | | electrode | | | | | | | | | |
| Example 10 | Three | Same as material of | Single | Same as negative | 35 | 22 | 35 | 1.6 | 1.6 | 10 | 99 |
| | layers | three layers of positive | layer | electrode | | | | | | | |
| | | electrode | | | | | | | | | |
| Example 11 | Three | Same as material of | Single | Same as negative | 35 | 14 | 35 | 2.5 | 2.5 | 6 | 99 |
| | layers | three layers of positive | layer | electrode | | | | | | | |
| | | electrode | | | | | | | | | |
| Example 12 | Three | Same as material of | Single | Same as negative | 35 | 14 | 35 | 2.5 | 2.5 | 20 | 99 |
| | layers | three layers of positive | layer | electrode | | | | | | | |
| | | electrode | | | | | | | | | |
| Example 13 | Three | Same as material of | Single | Same as negative | 35 | 14 | 35 | 2.5 | 2.5 | 40 | 99 |
| | layers | three layers of positive | layer | electrode | | | | | | | |
| | | electrode | | | | | | | | | |
| Example 14 | Three | Same as material of | Single | Same as negative | 35 | 14 | 35 | 2.5 | 2.5 | 80 | 99 |
| | layers | three layers of positive | layer | electrode | | | | | | | |
| | | electrode | | | | | | | | | |
| Example 15 | Three | Same as material of | Single | Same as negative | 35 | 14 | 35 | 2.5 | 2.5 | 120 | 99 |
| | layers | three layers of positive | layer | electrode | | | | | | | |
| | | electrode | | | | | | | | | |

TABLE 2

| | | | | | | Solid | | | | Number of | |
|---|---|---|---|---|---|---|---|---|---|---|---|
| | Columnar body in same layer | | Columnar body in same layer | | | electro- | | | | laminations | |
| | as layer of positive electrode | | as layer of negative electrode | | Positive | lyte | Negative | | | of | |
| | Number | Material of | Number | Material of | electrode | layer | electrode | | | laminated | Yield |
| | of Layers | columnar body | of Layers | columnar body | (μm) | (μm) | (μm) | L1/L3 | L2/L3 | body | (%) |
| Example 16 | Three | Same as material of | Single | Same as negative | 2 | 14 | 35 | 0.1 | 2.5 | 10 | 99 |
| | layers | three layers of | layer | electrode | | | | | | | |
| | | positive electrode | | | | | | | | | |
| Example 17 | Three | Same as material of | Single | Same as negative | 5 | 14 | 35 | 0.4 | 2.5 | 10 | 99 |
| | layers | three layers of | layer | electrode | | | | | | | |
| | | positive electrode | | | | | | | | | |
| Example 18 | Three | Same as material of | Single | Same as negative | 10 | 14 | 35 | 0.7 | 2.5 | 10 | 99 |
| | layers | three layers of | layer | electrode | | | | | | | |
| | | positive electrode | | | | | | | | | |
| Example 19 | Three | Same as material of | Single | Same as negative | 20 | 14 | 35 | 1.4 | 2.5 | 10 | 99 |
| | layers | three layers of | layer | electrode | | | | | | | |
| | | positive electrode | | | | | | | | | |
| Example 20 | Three | Same as material of | Single | Same as negative | 50 | 14 | 35 | 3.6 | 2.5 | 10 | 99 |
| | layers | three layers of | layer | electrode | | | | | | | |
| | | positive electrode | | | | | | | | | |
| Example 21 | Three | Same as material of | Single | Same as negative | 35 | 14 | 2 | 2.5 | 0.1 | 10 | 99 |
| | layers | three layers of | layer | electrode | | | | | | | |
| | | positive electrode | | | | | | | | | |
| Example 22 | Three | Same as material of | Single | Same as negative | 35 | 14 | 5 | 2.5 | 0.4 | 10 | 99 |
| | layers | three layers of | layer | electrode | | | | | | | |
| | | positive electrode | | | | | | | | | |
| Example 23 | Three | Same as material of | Single | Same as negative | 35 | 14 | 10 | 2.5 | 0.7 | 10 | 99 |
| | layers | three layers of | layer | electrode | | | | | | | |
| | | positive electrode | | | | | | | | | |
| Example 24 | Three | Same as material of | Single | Same as negative | 35 | 14 | 20 | 2.5 | 1.4 | 10 | 99 |
| | layers | three layers of | layer | electrode | | | | | | | |
| | | positive electrode | | | | | | | | | |
| Example 25 | Three | Same as material of | Single | Same as negative | 35 | 14 | 50 | 2.5 | 3.6 | 10 | 99 |
| | layers | three layers of | layer | electrode | | | | | | | |
| | | positive electrode | | | | | | | | | |

TABLE 3

| | Columnar body in | | Columnar body in | | | | | | | Number of | |
|---|---|---|---|---|---|---|---|---|---|---|---|
| | same layer as layer | | same layer as layer | | | Solid | | | | laminations | |
| | of positive electrode | | of negative electrode | | Positive | electrolyte | Negative | | | of | |
| | Number | Material of | Number of | Material of | electrode | layer | electrode | | | laminated | Yield |
| | of Layers | columnar body | Layers | columnar body | (μm) | (μm) | (μm) | L1/L3 | L2/L3 | body | (%) |
| Comparative | None | | None | | 35 | 22 | 35 | 1.6 | 1.6 | 10 | 88 |
| Example 1 | | | | | | | | | | | |
| Comparative | None | | None | | 35 | 18 | 35 | 1.9 | 1.9 | 10 | 83 |
| Example 2 | | | | | | | | | | | |
| Comparative | None | | None | | 35 | 14 | 35 | 2.5 | 2.5 | 10 | 43 |
| Example 3 | | | | | | | | | | | |
| Comparative | None | | None | | 35 | 10 | 35 | 3.5 | 3.5 | 10 | 33 |
| Example 4 | | | | | | | | | | | |
| Comparative | None | | None | | 35 | 8 | 35 | 4.4 | 4.4 | 10 | 31 |
| Example 5 | | | | | | | | | | | |
| Comparative | None | | None | | 35 | 6 | 35 | 5.8 | 5.8 | 10 | 25 |
| Example 6 | | | | | | | | | | | |
| Comparative | None | | None | | 35 | 4 | 35 | 8.8 | 8.8 | 10 | 20 |
| Example 7 | | | | | | | | | | | |
| Comparative | None | | None | | 35 | 14 | 35 | 2.5 | 2.5 | 6 | 55 |
| Example 8 | | | | | | | | | | | |
| Comparative | None | | None | | 35 | 14 | 35 | 2.5 | 2.5 | 3 | 63 |
| Example 9 | | | | | | | | | | | |
| Comparative | None | | None | | 35 | 14 | 35 | 2.5 | 2.5 | 2 | 81 |
| Example 10 | | | | | | | | | | | |

TABLE 4

| | Columnar body in | | Columnar body in | | | | | | | Number of | |
|---|---|---|---|---|---|---|---|---|---|---|---|
| | same layer as layer | | same layer as layer | | | Solid | | | | laminations | |
| | of positive electrode | | of negative electrode | | Positive | electrolyte | Negative | | | of | |
| | Number | Material of | Number | Material of | electrode | layer | electrode | | | laminated | Yield |
| | of Layers | columnar body | of Layers | columnar body | (μm) | (μm) | (μm) | L1/L3 | L2/L3 | body | (%) |
| Comparative | None | | None | | 2 | 14 | 35 | 0.1 | 2.5 | 10 | 79 |
| Example 11 | | | | | | | | | | | |
| Comparative | None | | None | | 5 | 14 | 35 | 0.4 | 2.5 | 10 | 77 |
| Example 12 | | | | | | | | | | | |
| Comparative | None | | None | | 10 | 14 | 35 | 0.7 | 2.5 | 10 | 45 |
| Example 13 | | | | | | | | | | | |
| Comparative | None | | None | | 20 | 14 | 35 | 1.4 | 2.5 | 10 | 45 |
| Example 14 | | | | | | | | | | | |
| Comparative | None | | None | | 50 | 14 | 35 | 3.6 | 2.5 | 10 | 23 |
| Example 15 | | | | | | | | | | | |
| Comparative | None | | None | | 35 | 14 | 2 | 2.5 | 0.1 | 10 | 82 |
| Example 16 | | | | | | | | | | | |
| Comparative | None | | None | | 35 | 14 | 5 | 2.5 | 0.4 | 10 | 80 |
| Example 17 | | | | | | | | | | | |
| Comparative | None | | None | | 35 | 14 | 10 | 2.5 | 0.7 | 10 | 47 |
| Example 18 | | | | | | | | | | | |
| Comparative | None | | None | | 35 | 14 | 20 | 2.5 | 1.4 | 10 | 45 |
| Example 19 | | | | | | | | | | | |
| Comparative | None | | None | | 35 | 14 | 50 | 2.5 | 3.6 | 10 | 26 |
| Example 20 | | | | | | | | | | | |

As shown in Tables 1 to 4, Examples 1 to 24 all had higher yields than Comparative Examples 1 to 20. That is, by providing the columnar body in the same layer as that of the positive electrode or negative electrode, cracking was less likely to occur in the inside of the all-solid state battery.

As shown in Comparative Examples 1 to 7 and Comparative Examples 11 to 20, in a case where the columnar body was not present, the yield tended to decrease as the thickness of the positive electrode or negative electrode increased as compared with the thickness of the solid electrolyte layer. This is considered to be because the larger the thickness of the positive electrode or negative electrode, the broader the interval between the solid electrolyte layers. In a case where the columnar body is not present, it is considered that the solid electrolyte layer distorts toward the gap between the solid electrolyte layers, whereby cracking is likely to occur in the all-solid state battery.

On the other hand, as shown in Examples 5 to 10 and Examples 16 to 25, in a case where the columnar body was present, there was no significant difference in yield even in a case where the thickness of the positive electrode or negative electrode was larger than the thickness of the solid electrolyte layer. This is considered to be because the columnar body supports a gap between the adjacent solid electrolyte layers, whereby distortion is less likely to occur. That is, the thicker the positive electrode or negative electrode is, the more effectively the columnar body functions, which makes it possible to prevent cracking in the all-solid state battery.

In addition, as shown in Comparative Examples 8 to 10, in a case where the columnar body was not present, the yield tended to decrease as the total number of positive electrodes and negative electrodes increased. This is considered to be because the distortion is more likely to occur at the end part of the laminated body as the total number of positive electrodes and negative electrodes increases. On the other hand, as shown in Examples 11 to 15, by providing a columnar body, a sufficient yield can be ensured even in a case where the total number of laminated bodies increases.

### Examples 26 to 58

In Examples 26 to 58, an all-solid state battery of the sixth modified example shown in FIG. 10 to FIG. 13 was produced. Examples 26 to 58 differ from Example 2 in that the paste that would serve as the columnar body was also formed in the portions that would serve as the second portions 46 and 66 and the third portions 47 and 67, which are shown in FIG. 10 and FIG. 11. The other conditions were the same as in Example 2.

In Examples 26 to 58, the columnar body present in the same layer as that of the positive electrode has the same layer configuration as the positive electrode. In Examples 26 to 57, the columnar body present in the same layer as that of the negative electrode was produced using a solid electrolyte paste. The thickness of the positive electrode was fixed at 35 μm, the thickness of the negative electrode was fixed at 35 μm, and the thickness of the solid electrolyte layer was fixed at 14 μm. In addition, the thickness of the columnar body present in the same layer as that of the positive electrode was fixed at 35 μm, and the thickness of the columnar body present in the same layer as that of the negative electrode was fixed at 35 μm. In addition, the total number of electrodes in the laminated body was fixed at 10 layers.

In Examples 26 to 58, a change was made in the width W1 of the first portion 65 of the columnar body 6 in the x direction, the width W2 of the void 7 in the x direction, the width W3 of the portion in the x direction, where the positive electrode 1 and the negative electrode 2 are overlapped in a case of being viewed from the z direction, the width W4 of the void 5 in the x direction, the width W5 of the first portion 45 of the columnar body 4 in the x direction, the width W6 of the second portion 46 of the columnar body 4 in the y direction, the width W7 of each of the voids 55 and 75 in the y direction, the width W8 of the portion in the y direction, where the positive electrode 1 and the negative electrode 2 are overlapped in a case of being viewed from the z direction, the width W9 of each of the voids 56 and 76 in the y direction, and the width W10 of the third portion 47 of the columnar body 4 in the y direction.

The results for Examples 26 to 58 are summarized in Table 5 and Table 6.

TABLE 5

| | Columnar body in same layer | | Columnar body in same layer | | | | | | | | | | | | | | | | |
|---|---|---|---|---|---|---|---|---|---|---|---|---|---|---|---|---|---|---|---|
| | as layer of positive electrode | | as layer of negative electrode | | | | | | | W4/ | W2/ | | | | | | W9/ | W7/ | Yield |
| | Number | Material of | Number | Material of | W3 | W4 | W5 | W2 | W1 | W5 | W1 | W8 | W9 | W10 | W7 | W6 | W10 | W6 | Rate |
| | of Layers | columnar body | of Layers | columnar body | (mm) | (mm) | (mm) | (mm) | (mm) | (—) | (—) | (mm) | (mm) | (mm) | (mm) | (mm) | (—) | (—) | (%) |
| Example | Three | Same as material of | Single | Same as material of | 3.80 | 0.38 | 0.38 | 0.38 | 0.38 | 1.00 | 1.00 | 2.70 | 0.38 | 0.38 | 0.38 | 0.38 | 1.00 | 1.00 | 98 |
| 26 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.50 | 0.30 | 0.38 | 0.38 | 1.67 | 1.00 | 2.70 | 0.38 | 0.38 | 0.38 | 0.38 | 1.00 | 1.00 | 97 |
| 27 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.60 | 0.20 | 0.38 | 0.38 | 3.00 | 1.00 | 2.70 | 0.38 | 0.38 | 0.38 | 0.38 | 1.00 | 1.00 | 96 |
| 28 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.70 | 0.10 | 0.38 | 0.38 | 7.00 | 1.00 | 2.70 | 0.38 | 0.38 | 0.38 | 0.38 | 1.00 | 1.00 | 98 |
| 29 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.75 | 0.05 | 0.38 | 0.38 | 15.00 | 1.00 | 2.70 | 0.38 | 0.38 | 0.38 | 0.38 | 1.00 | 1.00 | 93 |
| 30 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.30 | 0.50 | 0.38 | 0.38 | 0.60 | 1.00 | 2.70 | 0.38 | 0.38 | 0.38 | 0.38 | 1.00 | 1.00 | 97 |
| 31 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.20 | 0.60 | 0.38 | 0.38 | 0.33 | 1.00 | 2.70 | 0.38 | 0.38 | 0.38 | 0.38 | 1.00 | 1.00 | 98 |
| 32 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.10 | 0.70 | 0.38 | 0.38 | 0.14 | 1.00 | 2.70 | 0.38 | 0.38 | 0.38 | 0.38 | 1.00 | 1.00 | 97 |
| 33 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.05 | 0.75 | 0.38 | 0.38 | 0.07 | 1.00 | 2.70 | 0.38 | 0.38 | 0.38 | 0.38 | 1.00 | 1.00 | 92 |
| 34 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.50 | 0.30 | 1.00 | 1.67 | 2.70 | 0.38 | 0.38 | 0.38 | 0.38 | 1.00 | 1.00 | 98 |
| 35 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.60 | 0.20 | 1.00 | 3.00 | 2.70 | 0.38 | 0.38 | 0.38 | 0.38 | 1.00 | 1.00 | 98 |
| 36 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.70 | 0.10 | 1.00 | 7.00 | 2.70 | 0.38 | 0.38 | 0.38 | 0.38 | 1.00 | 1.00 | 97 |
| 37 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.75 | 0.05 | 1.00 | 15.00 | 2.70 | 0.38 | 0.38 | 0.38 | 0.38 | 1.00 | 1.00 | 91 |
| 38 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.30 | 0.50 | 1.00 | 0.60 | 2.70 | 0.38 | 0.38 | 0.38 | 0.38 | 1.00 | 1.00 | 97 |
| 39 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.20 | 0.60 | 1.00 | 0.33 | 2.70 | 0.38 | 0.38 | 0.38 | 0.38 | 1.00 | 1.00 | 97 |
| 40 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.10 | 0.70 | 1.00 | 0.14 | 2.70 | 0.38 | 0.38 | 0.38 | 0.38 | 1.00 | 1.00 | 98 |
| 41 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.05 | 0.75 | 1.00 | 0.07 | 2.70 | 0.38 | 0.38 | 0.38 | 0.38 | 1.00 | 1.00 | 90 |
| 42 | layers | three layers of | layer | solid electrolyte | | | | | | | | | | | | | | | |
| | | positive electrode | | layer | | | | | | | | | | | | | | | |

TABLE 6

| | Columnar body in same layer | | Columnar body in same layer | | | | | | | | | | | | | | | | |
|---|---|---|---|---|---|---|---|---|---|---|---|---|---|---|---|---|---|---|---|
| | as layer of positive electrode | | as layer of negative electrode | | | | | | | W4/ | W2/ | | | | | | W9/ | W7/ | Yield |
| | Number | Material of | Number | Material of | W3 | W4 | W5 | W2 | W1 | W5 | W1 | W8 | W9 | W10 | W7 | W6 | W10 | W6 | Rate |
| | of Layers | columnar body | of Layers | columnar body | (mm) | (mm) | (mm) | (mm) | (mm) | (—) | (—) | (mm) | (mm) | (mm) | (mm) | (mm) | (—) | (—) | (%) |
| Example | Three | Same as material of | Single | Same as material of | 3.80 | 0.38 | 0.38 | 0.38 | 0.38 | 1.00 | 1.00 | 2.70 | 0.50 | 0.30 | 0.38 | 0.38 | 1.67 | 1.00 | 98 |
| 43 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.60 | 0.20 | 0.38 | 0.38 | 3.00 | 1.00 | 98 |
| 44 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.70 | 0.10 | 0.38 | 0.38 | 7.00 | 1.00 | 97 |
| 45 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.75 | 0.05 | 0.38 | 0.38 | 15.00 | 1.00 | 91 |
| 46 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.30 | 0.50 | 0.38 | 0.38 | 0.60 | 1.00 | 97 |
| 47 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.20 | 0.60 | 0.38 | 0.38 | 0.33 | 1.00 | 97 |
| 48 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.10 | 0.70 | 0.38 | 0.38 | 0.14 | 1.00 | 98 |
| 49 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.05 | 0.75 | 0.38 | 0.38 | 0.07 | 1.00 | 97 |
| 50 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.38 | 0.38 | 0.50 | 0.30 | 1.00 | 1.67 | 98 |
| 51 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.38 | 0.38 | 0.60 | 0.20 | 1.00 | 3.00 | 98 |
| 52 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.38 | 0.38 | 0.70 | 0.10 | 1.00 | 7.00 | 97 |
| 53 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.38 | 0.38 | 0.75 | 0.05 | 1.00 | 15.00 | 91 |
| 54 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.38 | 0.38 | 0.30 | 0.50 | 1.00 | 0.60 | 97 |
| 55 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.38 | 0.38 | 0.20 | 0.60 | 1.00 | 0.33 | 97 |
| 56 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.38 | 0.38 | 0.10 | 0.70 | 1.00 | 0.14 | 98 |
| 57 | layers | three layers of | layer | solid electrolyte | | | | | | | | | | | | | | | |
| | | positive electrode | | layer | | | | | | | | | | | | | | | |
| Example | Three | Same as material of | Single | Same as material of | 3.80 | 0.38 | 0.38 | 0.38 | 0.38 | 1.00 | 1.00 | 2.70 | 0.38 | 0.38 | 0.05 | 0.75 | 1.00 | 0.07 | 97 |
| 58 | layers | three layers of | layer | solid electrolyte | | | | | | | | | | | | | | | |
| | | positive electrode | | layer | | | | | | | | | | | | | | | |

### REFERENCE SIGNS LIST

1 Positive electrode
11 Positive electrode current collector layer
12 Positive electrode active material layer
1A First positive electrode
1B Second positive electrode
2 Negative electrode
21 Negative electrode current collector layer
22 Negative electrode active material layer
2A First negative electrode
2B Second negative electrode
3 Solid electrolyte layer
4, 6 Columnar body
5, 7 Void
5A First void
5B Second void
41, 61 First layer
42, 62 Second layer
10, 10A, 10B, 10C Laminated body
80 Positive electrode terminal
90 Negative electrode terminal
100 All-solid state battery
S1 First surface
S2 Second surface
S3 Third surface
S4 Fourth surface

1. An all-solid state battery comprising:
a positive electrode;
a negative electrode;
a solid electrolyte layer between the positive electrode and the negative electrode; and
a first columnar body located at a position in the same layer as that of the positive electrode or the negative electrode in a manner spaced apart from the positive electrode or the negative electrode with a void being sandwiched between the first columnar body and the positive electrode or the negative electrode.

2. The all-solid state battery according to claim 1, wherein the first columnar body is spaced apart from the positive electrode in the same layer as that of the positive electrode, with the void being sandwiched between the first columnar body and the positive electrode.

3. The all-solid state battery according to claim 2, further comprising:
a second columnar body,
wherein the second columnar body is spaced apart from the negative electrode in the same layer as that of the negative electrode, with a void being sandwiched between the second columnar body and the negative electrode.

4. The all-solid state battery according to claim 1, further comprising:
a positive electrode terminal and a negative electrode terminal,
wherein the positive electrode terminal is connected to the positive electrode on a first surface of a laminated body including the positive electrode, the negative electrode, and the solid electrolyte layer,
the negative electrode terminal is connected to the negative electrode on a second surface of the laminated body different from the first surface, and
the first columnar body is present between the positive electrode terminal and the negative electrode or between the negative electrode terminal and the positive electrode.

5. The all-solid state battery according to claim 4, wherein the positive electrode terminal is in contact with the first surface and a surface adjacent to the first surface, and the positive electrode terminal is not in contact with the negative electrode.

6. The all-solid state battery according to claim 4, wherein the negative electrode terminal is in contact with the second surface and a surface adjacent to the second surface, and the negative electrode terminal is not in contact with the positive electrode.

7. The all-solid state battery according to claim 1, wherein the first columnar body has the same layer configuration as the positive electrode or the negative electrode.

8. The all-solid state battery according to claim 1, wherein a thickness of the positive electrode is 2.5 times or more with respect to a thickness of the solid electrolyte layer.

9. The all-solid state battery according to claim 1, wherein a thickness of the negative electrode is 2.5 times or more with respect to a thickness of the solid electrolyte layer.

10. The all-solid state battery according to claim 1, wherein the positive electrode has a thickness of 10 μm or more.

11. The all-solid state battery according to claim 1, wherein the negative electrode has a thickness of 10 μm or more.

12. The all-solid state battery according to claim 1, wherein the positive electrode is at least one layer,
the negative electrode is at least one layer, and
a total number of the positive electrodes and the negative electrodes is 3 or more.

13. The all-solid state battery according to claim 1, wherein a laminated body including the positive electrode, the negative electrode, and the solid electrolyte layer has a first positive electrode and a second positive electrode, which are adjacent to each other in a lamination direction, and
a first void present between the first positive electrode and the columnar body in the same layer as that of the first positive electrode and a second void present between the second positive electrode and the columnar body in the same layer as that of the second positive electrode are at least partially overlapped in a case of being viewed from the lamination direction of the laminated body.

14. The all-solid state battery according to claim 13, wherein 80% or more of the first void is overlapped with the second void in a case of being viewed from the lamination direction of the laminated body.

15. The all-solid state battery according to claim 1, wherein a laminated body including the positive electrode, the negative electrode, and the solid electrolyte layer has a first negative electrode and a second negative electrode, which are adjacent to each other in a lamination direction, and
a third void present between the first negative electrode and the columnar body in the same layer as that of the first negative electrode and a fourth void present between the second negative electrode and the columnar body in the same layer as that of the second negative electrode are at least partially overlapped in a case of being viewed from the lamination direction of the laminated body.

16. The all-solid state battery according to claim 15, wherein 80% or more of the third void is overlapped with the fourth void in a case of being viewed from the lamination direction of the laminated body.

17. The all-solid state battery according to claim 1, further comprising:
a first region containing a solid electrolyte constituting the solid electrolyte layer between the positive electrode or the negative electrode and the first columnar body, in the same layer as that of the positive electrode or the negative electrode.

18. The all-solid state battery according to claim 1, wherein further comprising:
a third columnar body between the positive electrode or the negative electrode and the first columnar body in the same layer as that of the positive electrode or the negative electrode.

19. The all-solid state battery according to claim 1, wherein in a case where a direction from the first columnar body toward the positive electrode or the negative electrode in the same layer as that of the positive electrode or the negative electrode is defined as a first direction, where the void is sandwiched between the first columnar body and the positive electrode or the negative electrode, and a direction intersecting the first direction is defined as a second direction, a part of the first columnar body or a fourth columnar body is present at a position in the second direction of the positive electrode or the negative electrode.

20. The all-solid state battery according to claim 1, wherein in a case where a direction from the first columnar body toward the positive electrode or the negative electrode in the same layer as that of the positive electrode or the negative electrode is defined as a first direction, where the void is sandwiched between the first columnar body and the positive electrode or the negative electrode, a width of the void in the first direction is 0.07 times or more or 15.0 times or less with respect to a width of the first columnar body in the first direction.
